(19) United States
(12) Patent Application Publication
(10) Pub. No.: US 2014/0234722 A1
(43) Pub. Date: Aug. 21, 2014

(54) Si/C COMPOSITE MATERIAL, METHOD FOR MANUFACTURING THE SAME, AND ELECTRODE

(71) Applicants: Takashi Kyotani, Sendai-shi (JP); Hirotomo Nishihara, Sendai-shi (JP); Shinichiroh Iwamura, Sendai-shi (JP)

(72) Inventors: Takashi Kyotani, Sendai-shi (JP); Hirotomo Nishihara, Sendai-shi (JP); Shinichiroh Iwamura, Sendai-shi (JP)

(73) Assignee: TOHOKU UNIVERSITY, Sendai-shi, Miyagi (JP)

(21) Appl. No.: 14/241,839

(22) PCT Filed: Aug. 31, 2012
(86) PCT No.: PCT/JP2012/072273

§ 371 Date: Apr. 29, 2014

(30) Foreign Application Priority Data
Aug. 31, 2011 (JP) 2011-190110

(51) Int. Cl. H01M 4/36; H01M 4/1393; H01M 4/04

(52) U.S. Cl. CPC H01M 4/366; H01M 4/0428; H01M 4/1393; H01M 2004/021
USPC 429/231.8; 427/122

(57) ABSTRACT

The present invention provides composite material in which Si and carbon are combined so as to form an unprecedented structure; method for fabricating the same; and negative electrode material for lithium-ion batteries ensuring high charge-discharge capacity and high cycle performance. By heating an aggregate of Si nanoparticles and using a source gas containing carbon, a carbon layer is formed on each of the Si particles. Walls 12 forming a space 13a containing Si particles 11 and a space 13b not containing Si particles 11 are constructed by this carbon layer.

### TECHNICAL FIELD

The present invention relates to composite material of Si and carbon, method for manufacturing the same, and electrode using the composite material.

### BACKGROUND ART

Lithium-ion rechargeable batteries using LiCoO₂ for a positive electrode and graphite for a negative electrode have generally been used. Meanwhile, whereas the theoretical battery capacity is 372 mAh/g (840 mAh/cm³) when graphite is used as a negative electrode, the theoretical battery capacity is 4200 mAh/g (9790 mAh/cm³) when Si is used, meaning that Si ensures theoretical battery capacity more than 10 times higher than that of graphite. Hence, Si is attracting attention as a next-generation negative electrode material.

However, there are problems. Firstly, Si has low conductivity, secondly its reaction rate with Li is low, causing its rate characteristics to be poor, and thirdly its volume increases up to four times that of the original volume at the time of charging. Consequently, the electrode itself may be damaged, causing cycle performance to degrade. Degraded cycle performance, in particular, is an obstacle to practical realization of Si as a negative electrode material. To solve these problems, and thus utilize the large charge-discharge capacity of Si, a number of studies have been conducted.

Of those studies, some have recently disclosed that by ensuring a space having a role of buffering volume expansion around Si, high charge-discharge capacity can be obtained (non-patent literatures 1 and 2, for example).

Under such circumstances, the inventors have conducted research, and developed a Si/C composite having a nanospace around Si (non-patent literatures 3 and 4). This Si/C composite is fabricated by basically following the procedure described below. Si nanoparticles are subjected to heat treatment under air flow to thicken a SiO₂ layer on the surface, and then molded into a pellet. Polyvinyl chloride (PVC) is placed on the pellet, and heat treatment is performed at approximately 300° C. to liquefy the PVC, thereby impregnating the pellet with PVC. Heat treatment is performed at approximately 900° C. to carbonize the PVC. The carbon on the exterior of the pellet is removed, and the oxide layer on the surface of Si nanoparticles is removed by HF treatment to obtain the Si/C composite.

### CITATION LIST

### Non-Patent Literature

Non-patent literature 1: Cui, L. F.; Ruffo, R.; Chan, C. K.; Peng, H. L.; Cui, Y. Nano Letters 2009, 9, 491
Non-patent literature 2: Magasinski, A.; Dixon, P.; Hertzberg, B.; Kvit, A.; Ayala, J.; Yushin, G. Nature Materials, 2010, 9, 353.
Non-patent literature 3: Iwamura, Shinichiroh.; Nishihara, Hirotomo.; Kyogoku, Takashi. “Synthesis of a Si/C nanocomposite material having a space allowing volume change of Si,” 36th Preliminary Draft Collection of the Year of the Carbon Society of Japan, Carbon Society of Japan, Nov. 30, 2009, pp. 196-197.
Non-patent literature 4: Iwamura, Shinichiroh.; Nishihara Hirotomo.; Kyogoku, Takashi. “Li charge-discharge characteristics of a Si/C composite having a nanospace around Si,” 9th Preliminary Draft Collection of the Institute of Multidisciplinary Research for Advanced Materials Tohoku University, Institute of Multidisciplinary Research for Advanced Materials Tohoku University, Dec. 10, 2009, p. 40.

### SUMMARY OF INVENTION

### Technical Problem

However, when the Si/C composite thus obtained is used as a negative electrode material for lithium-ion batteries, its charge-discharge capacity remains small, and with the increase of the number of cycles, the charge-discharge capacity decreases. This phenomenon is considered to occur because Si particles become detached from the electrode as a result of repetitive charge-discharge, and consequently the capacity inherent to Si is not utilized thoroughly.

It is an object of the present invention to provide composite material wherein Si and carbon are combined so as to form an unprecedented structure, method for fabricating the same, and negative electrode materials for lithium-ion batteries having high charge-discharge capacity and high cycle performance.

### Solution to Problem

In order to achieve the above object, a composite material of the present invention is characterized by including Si particles of nano-size; and walls having carbon-layer, the walls forming a space containing the Si particles and a space not containing the Si particles.

In the above structure, a surface of the Si particles may be oxidized.

In the above structure, the carbon layer preferably has an average thickness ranging from 0.34 to 30 nm.

In the above structure, the carbon layer in a laminated graphene structure is preferably formed on a surface of the Si particles.

A maximum charge-discharge capacity is 2000 mAh/g or higher, otherwise 2500 mAh/g or higher when the composite is used in a negative electrode material.

In the above structure, the Si particles preferably have average particle size ranging from 1×10 to 1.3×10² nm.

A negative electrode material for lithium-ion batteries of the present invention includes a composite material of the present invention.

An electrode of the present invention is used for making up of the negative electrode material for lithium-ion batteries of the present invention. The charge-discharge capacity falls within a range from 1.0×10³ to 3.5×10³ mAh/g when the electrode assembly is used as a negative electrode.

In order to achieve the above object, a method of fabricating a composite material of the present invention is characterized by heating an aggregate of Si nanoparticles; and forming a carbon layer on each of Si particles using a source gas containing carbon, thereby making walls of carbon-layer, the walls forming a space containing Si particles and a space not containing Si particles.

In the above structure, forming an oxide layer on a surface of each of the Si particles in the aggregate, thereby forming the walls on the oxide layer so that the walls surround each of the Si particles; and then dissolving the oxide layer, thereby may be making a hollow in a part between the carbon layer and each of the Si particles.

In the above structure, after the carbon layer is formed, heat treatment is preferably performed at a temperature higher than a level at which the carbon layer is formed.

In the above structure, the aggregate may be compressed to be molded it into a pellet before forming the walls. In this case, a pulse CVD method is preferably used to form the carbon layer.

In the above structure, the carbon layer can be formed on the condition to have an average thickness falling within a range from 0.34 to 30 nm.

In the above structure, each of the Si particles have an average particle size falling within a range from 1×10 to 1.3×10² nm.

### Advantageous Effect of Invention

According to the present invention, a composite material contains Si nanoparticles and carbon-layer walls that separate a space containing Si particles from a space not containing Si particles. An electrode is made by using this composite material as a negative electrode material for lithium-ion batteries. Si particles expand at the time of charging, the space not containing the Si particles decreases while the space containing the Si particles increases, and thus the state where Si particles are contained can be maintained. Consequently, high charge-discharge capacity and a beneficial effect that repetitive charge-discharge does not decrease the charge-discharge capacity are ensured.

### BRIEF DESCRIPTION OF DRAWINGS

FIG. 1A is a view schematically illustrating a composite according to an embodiment of the present invention.

FIG. 1B is a view schematically illustrating a composite according to another embodiment of the present invention.

FIG. 2 is a view schematically illustrating a first method for fabricating a composite material according to an embodiment of the present invention.

FIG. 3 is a view schematically illustrating a second method for fabricating a composite material according to an embodiment of the present invention.

FIG. 4 is a view schematically illustrating a third method for fabricating a composite material according to an embodiment of the present invention.

FIG. 5 is a chart showing the particle diameter distribution of Si particles used in Example 1.

FIG. 6 is a view showing a transmission electron microscopic image of the composite fabricated in Example 1.

FIG. 7 is a view showing transmission electron microscopic images of the composite obtained in Example 2.

FIG. 8 is a view showing transmission electron microscopic images of the composite obtained in Example 3.

FIG. 9 is a view showing transmission electron microscopic images of the composite fabricated in Comparative Example 1.

FIG. 10 is a chart showing the charge-discharge characteristics in Example 1 and Comparative Example 1.

FIG. 11 is a chart showing the charge-discharge characteristics in Examples 2 and 3.

FIG. 12 is chart showing the results of the Raman measurement of the composites obtained in Examples 1 and 3.

FIG. 13 is a Transmission Electron Microscope (TEM) image of the composite in Example 3 used as a negative electrode material for a lithium-ion battery, wherein (a), (b), and (c) are TEM images of the composite before charge-discharge cycle, after 5 cycles, and after 20 cycles respectively;

FIG. 14 (a) to (c) are the illustrations of each image in FIG. 13;

FIG. 15 is a chart showing the XRD patterns of crystalline structure of the samples, Si/C (900), Si/C (1000), and Si/C (1100);

FIG. 16 is a chart showing the charge-discharge characteristics in Example 4;

FIG. 17 is a TEM image of Si/C (900), which has high capacity and good cycle characteristics;

FIG. 18 shows the charge-discharge characteristics of the Si/C (900) sample obtained by performing heat treatment at 900° C.;

FIG. 19 is a chart showing the charge-discharge characteristics of the case where the nano-Si/C composite obtained in Example 5 was used.

FIG. 20 (a) is a TEM image of the Si nanoparticles in the electrode after 20 cycles, FIG. 20 (b) is a TEM image of the Si nanoparticles in the electrode after 100 cycles, FIG. 20 (c) is a TEM image of the Si/C composite in the electrode after 20 cycles, FIG. 20 (d) is a TEM image of the Si/C composite in the electrode after 100 cycles;

FIG. 21 is a chart showing the cycle characteristics of charge-discharge capacity obtained when restriction was put so that the capacity did not exceed 1500 mAh/g;

FIG. 22 is a TEM image of the Si/C composite after 100 cycles.

FIG. 23 is a chart showing the cycle characteristics of charge-discharge capacity when a restriction was put so that the capacity did not exceed 1500 mAh/g and the average particle size of the Si nanoparticles was 80 nm;

FIG. 24 is a chart showing the charge-discharge characteristics of Example 6;

FIG. 25 is a chart showing the charge-discharge characteristics of Comparative Example 3.

FIG. 26 is a chart showing the result of investigation of the effect of difference in the existence condition of carbon on the charge-discharge characteristics of Si nanoparticles.

### REFERENCE SIGN LIST

1, 2: Si/C composite material (composite)
11: Si particle
12: Wall
13a: Space containing Si particles
13b: Space not containing Si particles
21, 31, 41: Si particle
22: Oxide layer
23: Silicon oxide layer
24, 32, 42: Carbon layer
43: Miniaturized Si

### DESCRIPTION OF EMBODIMENTS

Embodiments of the present invention will hereinafter be described by referring to drawings. Composite material of Si and carbon according to the embodiments of the present invention (hereinafter referred to as the “composite material” or “composite”) are used in negative electrode material for lithium-ion batteries, for example.

[Composite Material]

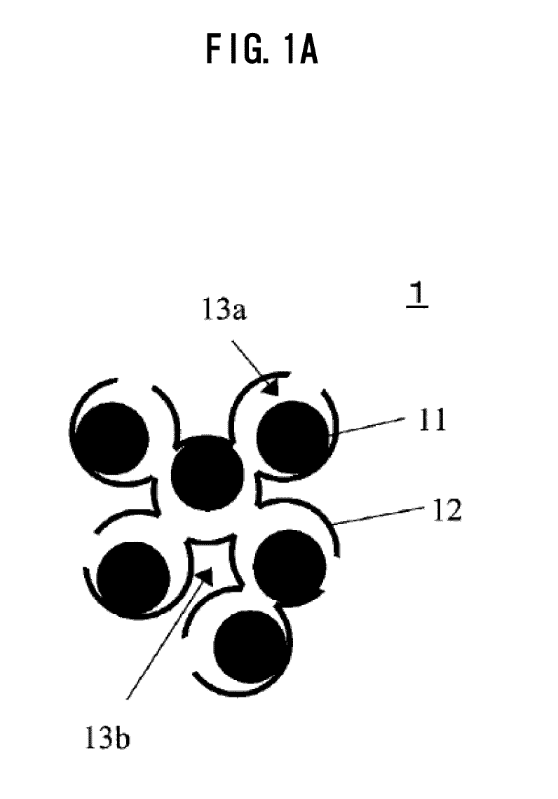

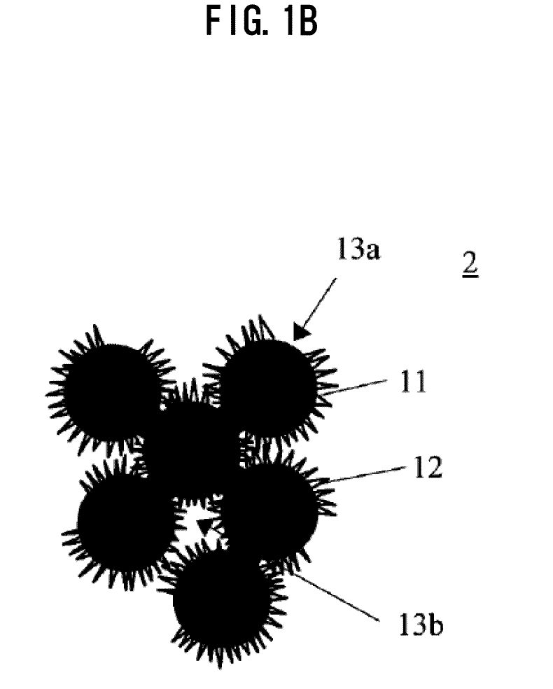

FIGS. 1A and 1B are views schematically illustrating the composite material according to the embodiments of the present invention. As shown in FIGS. 1A and 1B, the composite material 1, 2 according to the embodiments of the present invention are made up of Si nanoparticles 11 and carbon-layer walls 12. The carbon-layer walls 12 form a space 13a containing Si particles 11 and a space 13b not containing Si particles 11. As far as the walls 12 retain the Si particles 11, the walls 12 are permitted to be called a framework.

In the embodiment shown in FIG. 1A, in the space 13a containing the Si particles 11, areas containing a Si particle 11 are connected with one another, with the Si particles 11 adhered to the carbon-layer walls 12 that form those areas. The space surrounded by the carbon-layer walls 12 includes a space 13b that does not contain Si particles 11 and a space 13a that contains Si particles 11. Each area containing the Si particle 11 is made up of a region that is occupied by the Si particle 11 and a region that is not occupied by the Si particle 11, namely non-occupied area. In other words, the cavity of this material is made up of regions not occupied by the Si particles (non-occupied area), of the space 13a, and the space 13b. The volume of these entire cavities is approximately three times that of the areas occupied by the Si particles 11 or more. As far as the cavity volume falls within this range, when the volume of Si particles 11 expands to three to four times its original volume by Li ions at the time of charging performed, using this composite material as a negative electrode material for a lithium ion battery, the cavity also functions as a buffer area, thus preventing the carbon-layer 12 from being damaged. In the case of that the cavity volume is three times the area occupied by the Si particles 11 or smaller, when the Si particles expand to three times or more of its original volume due to charging, the carbon layer 12, which is a conductive path, will be damaged and the Si particles are electrically insulated, and consequently inhibited from operating as a negative electrode.

Composite material 2 according to the embodiment shown in FIG. 1B is in a state where Si particles 11 are agglomerated and connected with one another, and extendable-contractible accordion-shaped graphene-layer walls 12 are formed on the surface of the connected agglomerated bodies. An ultra-thin oxide layer is formed on the surface of the Si particles 11, and the Si particles 11 may be connected by these oxide layers. Namely, with the composite material 2 shown in FIG. 1B, areas containing Si particles 11 are connected with one another in the space 13a containing Si particles 11, and the Si particles 11 are attached to the walls that form the areas. The Si particle 11 occupies most of each of these areas. An oxide layer may be formed on the surface of the Si particle 11, and an oxide layer may exist between the Si particle 11 and the carbon-layer wall 12. In the embodiment shown in FIG. 1B, since the accordion-shaped graphene layer itself can buffer the expansion of Si particles, the space volume is not necessarily be approximately three times that of the areas occupied by Si particles 11 or larger.

In either of the composite material 1, 2, Si particles 11 have the size equal to a sphere having equivalent sectional area diameter of 10 nm to 130 nm, which is expressed in this description as having an average diameter of 10 nm to 130 nm. The Si particles 11 may be in an amorphous or crystalline Si structure. Shallow areas on the surface of the Si particles 11 may be oxidized.

The walls 12 are made of carbon layer, and a part or the whole of the carbon layer is made of layered graphite, or has a rough structure not containing graphite. An atomic layer of graphite (called “graphene”) is in a hexagonal lattice structure. The carbon layer has an average thickness of 0.34 to 30 nm.

When an electrode is structured by using the composite material 1, 2 according to the embodiments of the present invention in negative electrode materials for lithium-ion batteries, the charge-discharge capacity as high as 1.0×10³ to 3.5×10³ mAh/g can be achieved.

[Method for Fabrication]

A method for fabricating a composite material according to the embodiment of the present invention includes heating an aggregate of Si nanoparticles and forming a carbon layer on each of Si particles by a source gas containing carbon. Consequently, as shown in FIGS. 1A and 1B, walls 12 that form a space 13a containing Si particles 11 and a space 13b not containing Si particles 11 are constructed.

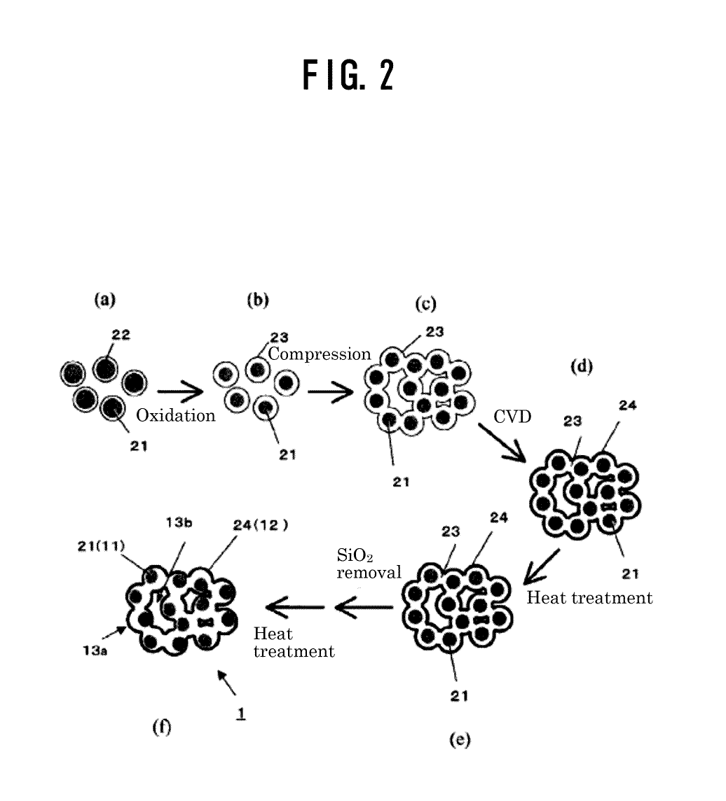

FIG. 2 is a view schematically illustrating a second fabrication method. The outline of the fabrication process will be described sequentially.

As shown in FIG. 2 (a), Si nanoparticles 21 are gathered. The surface of each Si particle 21 is oxidized. An oxide layer 22 is formed.

In an oxide layer formation process shown in FIG. 2 (b), the Si nanoparticles 21 are then subjected to heat treatment in an oxygen atmosphere or a mixed gas atmosphere containing oxygen to form a silicon oxide layer 23 on the oxide layer 22 of the Si particles 21.

In a pellet formation process shown in FIG. 2 (c), Si particles 21 having a silicon oxide layer 23 on their surface are aggregated and compressed to be formed into a pellet.

In a carbon layer formation process shown in FIG. 2 (d), the pellet is then placed in a reaction vessel, and a source gas containing carbon is fed in a state where the temperature is maintained at a specified level. A carbon layer 24 can thus be formed on the surface of the silicon oxide layer 23 in the pellet.

Then, in a heat treatment process shown in FIG. 2 (e), the temperature is increased from that of the carbon layer formation process, and heat treatment is performed with the temperature maintained at that level in order to enhance the crystallinity of the carbon layer 24 formed in the carbon layer formation process.

In a silicon oxide layer removal process, the silicon oxide layer 23 is dissolved to remove the silicon oxide layer 23 existing between the Si particle 21 and the carbon layer 24. In this case, since a large number of nanopores exist in the carbon layer 24, the solvent used for dissolving the silicon oxide layer 23 infiltrates the carbon layer 24.

Heat treatment is then performed as a post-treatment process to stabilize the carbon layer 24, thus forming walls 12.

By the processes described above, a composite 1 of Si and carbon, wherein the space 13a containing Si particles 11 and the space 13b not containing Si particles are separated by the carbon layer 24, is obtained.

Each of the above processes will be described more specifically. In the pellet formation process, for example, compression is performed under vacuum to form a pellet.

The temperature in the carbon layer formation process falls within a range from 500° C. to 1200° C. If the temperature is below 500° C., carbon hardly deposits on the surface. If the temperature exceeds 1200° C., Si and carbon react with each other, forming Si—C connection, which is undesirable.

Since molding is performed to form a pellet in this production process, it is desirable that a vacuum pulse CVD method be used. With the vacuum pulse CVD method, by placing a pellet in a reaction vessel, maintaining the vessel in vacuum, and feeding a gas once or repetitively for a specified period of time, pressure gradient is generated from inside to outside of the pellet, and this pressure gradient is used as a driving force to allow the gas to infiltrate the pellet. Carbon can thus be deposited not only on the outer surface of the pellet formed by compressing the Si particles but also on the surface of the Si particles existing within the pellet.

It is only necessary that the source gas containing carbon can be gasified at the reaction temperature and that it contains carbon. The source gas can be selected as required from hydrocarbons such as methane, ethane, acetylene, propylene, butane, and butene, aromatic compounds such as benzene, toluene, naphthalene, pyromellitic dianhydride, alcohols such as methanol and ethanol, and nitrile compounds such as acetonitrile and acrylonitrile.

In the heat treatment and post-treatment processes, the temperature is maintained at the same level as or higher than that of the carbon layer formation process in a vacuum atmosphere or in an atmosphere of inert gas such as nitrogen. Carbon formed in a network pattern is thus stabilized.

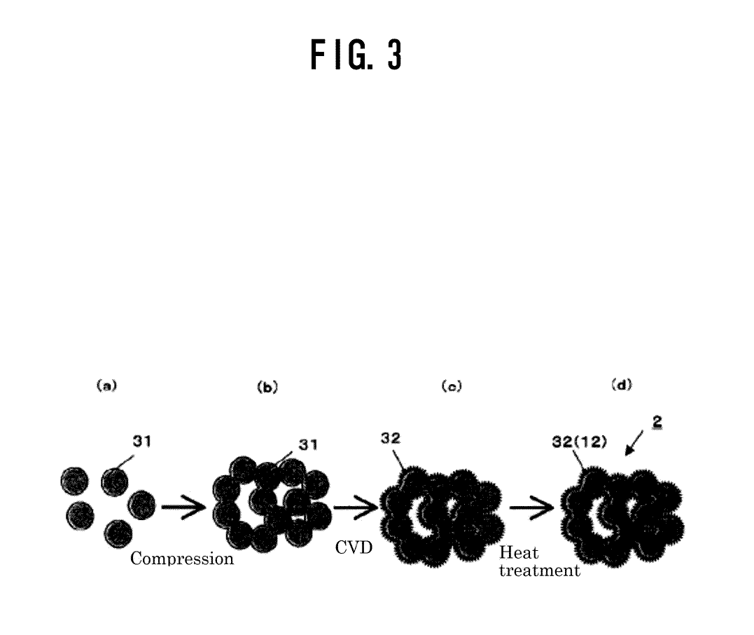

A second method for fabricating a composite material of the present invention will then be described. FIG. 3 is a view schematically illustrating a second fabrication method. With the second fabrication method, a process of forming an oxide layer is not performed, and a process of forming a pellet, that of forming a carbon layer, and heat treatment process are performed sequentially. In this series of processes, even if a natural oxide layer may be formed on the surface of Si particles, this natural oxide layer need not necessarily be removed in a positive manner.

As shown in FIG. 3 (a), Si nanoparticles 31 are gathered. A state where the surface of the Si particles 31 is oxidized, thus forming an oxide layer, is permitted.

Then, in the process of forming a pellet shown in FIG. 3 (b), Si particles 31 are gathered and compressed to be formed into a pellet.

In the process of forming a carbon layer shown in FIG. 3 (c), the pellet is placed in a reaction vessel, and a source gas containing carbon is fed in a state where the temperature is maintained at a specified level. Consequently, a carbon layer 32 is formed on the surface of the Si particles 31 within the pallet.

In the heat treatment process shown in FIG. 3 (d), the temperature is increased to higher than that of the carbon layer forming process, and heat treatment is performed with the temperature maintained at that level. The crystallinity of the carbon layer 32 formed in the carbon layer forming process is thus increased to form walls 12.

The processes described above provide a composite 2 of Si and carbon. The details of each process are the same as those of the first fabrication method.

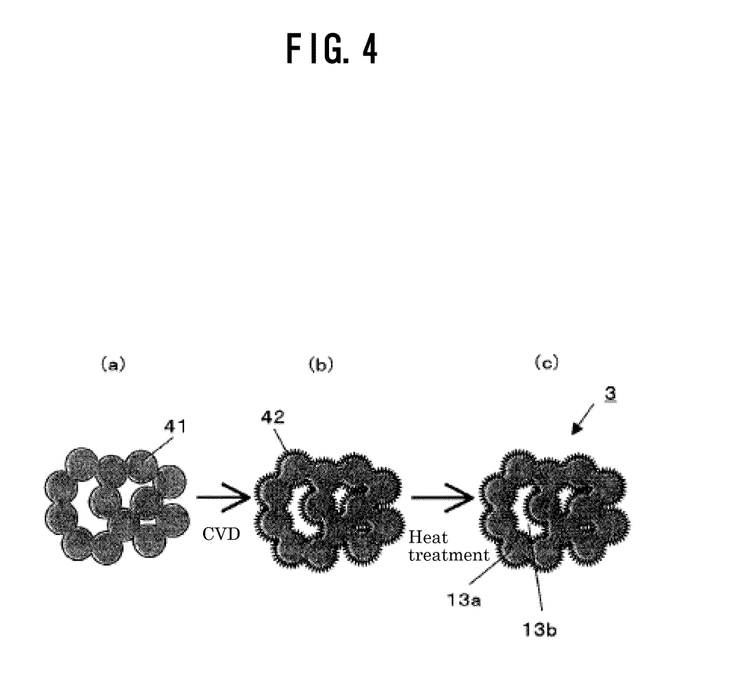

A third method of fabrication will hereafter be described. FIG. 4 is a view illustrating a third fabrication method.

With the third fabrication method, Si particles 41 that have spontaneously agglutinated as shown in FIG. 4 (a) are used without performing a pellet forming process, unlike the case of the second fabrication method. The spontaneously agglutinated Si particles are placed in a reaction vessel in the carbon layer forming process, and a source gas containing carbon is fed in a state where the temperature is maintained at a specified level. A carbon layer 42 is thus formed on the surface of the Si particles 41 or on the silicon oxide layer on the surface of the Si particles 41 as shown in FIG. 4 (b).

Then in the heat treatment process shown in FIG. 4 (c), the temperature is increased to higher than that of the carbon layer forming process, and heat treatment is performed with the temperature maintained at that level. The purpose of this process is to increase the crystallinity of the carbon layer 42 formed in the carbon layer forming process.

The processes described above provide a composite 3 of Si and carbon, wherein the space 13a containing Si particles 11 and the space 13b not containing Si particles are separated by the carbon layer 42.

In this series of processes also, if the spontaneous oxide layer existing on the surface of the Si nanoparticles is extremely thin, this spontaneous oxide layer need not be removed in a positive manner.

With the composite 3 obtained by the third fabrication method, Si nanoparticles 41 have spontaneously agglutinated, with Si particles connected with one another, thus forming a network. Consequently, the process of compression molding need not be performed, unlike the cases of the first and the second fabrication methods.

With any one of the fabrication methods, the Si particles can be selected as required, provided that their diameter falls within a range approximately from dozens to a hundred and several tens nm. For example, those having diameters falling within a range from 20 nm to 30 nm, the average particle size being 25 nm, those having diameters falling within a range from 50 nm to 70 nm, the average particle size being 70 nm, or those having diameters falling within a range from 110 to 130 nm, the average particle size being 125 nm, can be selected, for example. The Si particles desirably has a size within these ranges, but there is no problem if Si particles having a diameter of several hundred nm may coexist.

### Example 1

The present invention will hereinafter be described further in detail by referring to examples. Example 1 was performed according to the process shown in FIG. 2.

By subjecting Si nanoparticles having average particle size of 60 nm to heat treatment at 900° C. for 200 minutes in an atmosphere of mixed gas of 80 vol % argon and 20 vol % of oxygen, the thickness of a SiO₂ layer that had existed on the surface of the Si nanoparticles was increased further to generate Si particles on whose surface SiO₂ was formed (hereinafter referred to as “Si/SiO₂ particles”).

Then the Si/SiO₂ particles were compressed at 700 MPa under vacuum using a pellet forming machine to form them into a 12 nm-dia. disk-shaped pellet.

This pellet was heated to 750° C., and vacuuming was performed for 60 seconds with the temperature maintained at 750° C., and then a mixed gas of 20 vol % acetylene and 80 vol % nitrogen was fed to this pellet for one second. This cycle was repeated 300 times to allow carbon to deposit on the surface of Si/SiO₂ particles.

The temperature was then increased to 900° C. and maintained at that level for 120 minutes as heat treatment to increase the crystallinity of the carbon. The pellet was then agitated in a 0.5 mass % hydrofluoric acid solution for 90 minutes to dissolve the SiO₂ layer, thus removing the oxide film. Lastly, the temperature was then increased to 900° C. once again and maintained at that level for 120 minutes as heat treatment. A composite material of silicon and carbon was thus obtained.

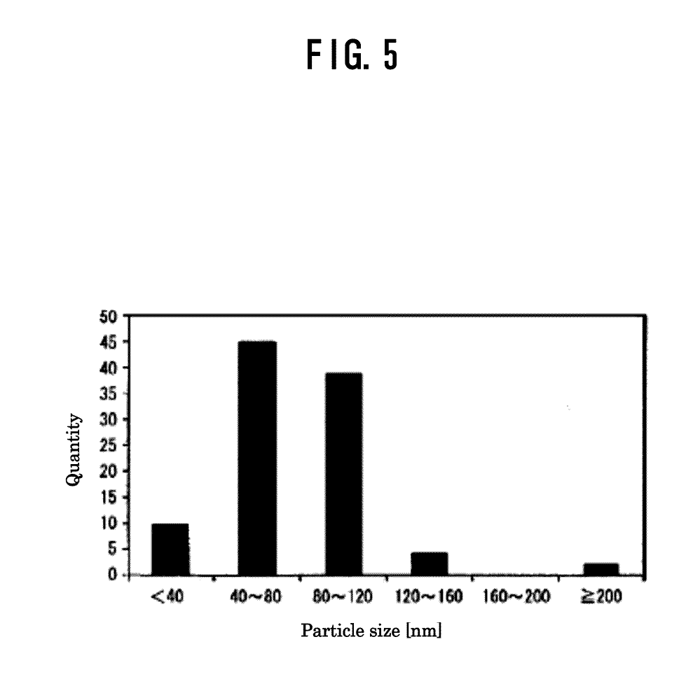

FIG. 5 is a chart showing the particle diameter distribution of Si particles used in Example 1. The horizontal axis represents particle diameter in nm, and the vertical axis represents quantity. Of the Si particles used in Example 1, 100 particles were selected at random, and the diameter of each particle was found by measurement using SEM images. FIG. 5 shows that more than 80% of the Si particles used in Example 1 fell within the range from 40 to 120 nm. The average particle size was found to be 76 nm.

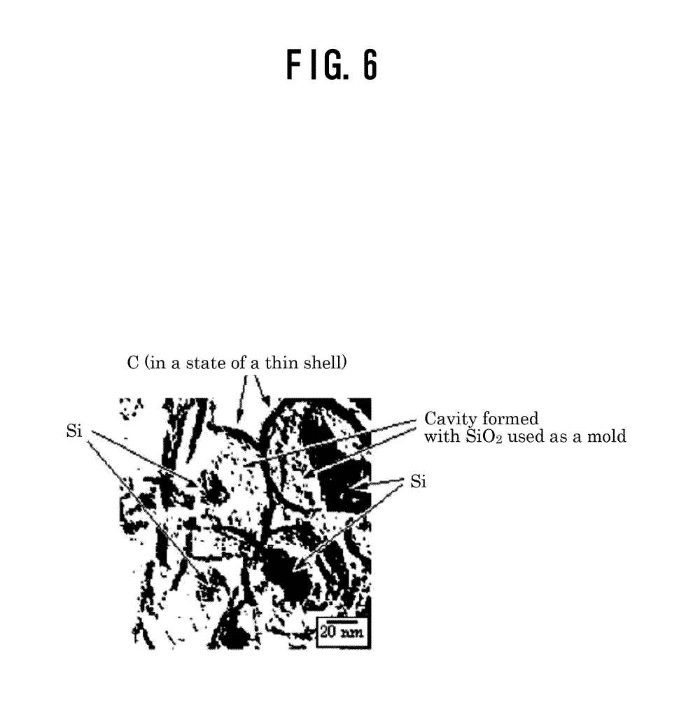

FIG. 6 is a view showing a transmission electron microscopic (TEM) image of the composite fabricated in Example 1. It is apparent from FIG. 6 that Si particles are housed in thin carbon frameworks in a state where a cavity is formed between the carbon layer and the Si particles. It was also found that the carbon frameworks form a space containing Si particles and having a cavity between the surface of the Si particle and the inner peripheral surface of the carbon, and a space not containing Si particles and having cavities formed only by carbon surfaces. The carbon frameworks divide a plurality of enclosed spaces. As shown in FIG. 6, there are spaces containing Si particles and those not containing Si particles. The space containing Si particles may be larger or smaller than the space not containing Si particles, and in the sample shown in FIG. 6, the space containing Si is 1.2 times larger than that of the space not containing Si in equivalent cross-sectional radius. This value was found by calculating the volume ratio from the filling factor of the pellet and the Si/SiO₂ ratio of the particles, with the thickness of the carbon layer assumed to be 3 nm and each space assumed to be in a uniform spherical shape.

As a result of calculating the Si/SiO₂ ratio of the Si/SiO₂ particles before they were formed into a pellet, SiO₂ of the volume 2.7 times that of Si was found to have existed. The Si/SiO₂ ratio was calculated from the value obtained by performing heat treatment in an air atmosphere at 1400° C. for two hours, and measuring the increase in weight after complete oxidation had occurred.

With the fabrication method in Example 1, the SiO₂ layer existing around Si serves as a mold, and a space around the Si in the composite allows the Si to expand in volume to 3.7 times the original volume exists. Consequently, because of the existence of the space formed with SiO₂ serving as a mold, Si volume expansion of up to four times the original volume that occurs at the time of charging can be buffered almost completely.

Furthermore, from the TEM image, small cavities are also confirmed to exist among carbon frameworks. As a result, even if Si particles having a diameter too large to fit into the space around the Si particle appear as a result of volume expansion, no structural disorder of the composite is assumed to occur easily because the cavities among carbon frameworks not containing Si also buffer the volume expansion of Si.

The composite was subjected to heat treatment in an air atmosphere at 1400° C. for two hours, and the change in weight was measured after complete oxidation had occurred to calculate the Si/C ratio of the composite. As the Si/C ratio of the composite, Si was found to be contained by 65 wt %. The theoretical capacity of this composite per weight is calculated to be 2850 mAh/g from the theoretical capacity of carbon and Si.

As shown in Comparative Example 1 to be described later, with the composite having a space around Si with PVC used as a carbon source, the Si content in the composite was found to be approximately 21 mass % because the cavities around Si particles are filled with carbon completely.

Since the carbon layer was made to deposit thinly around Si particles in Example 1, the Si content of the composite was able to be increased significantly.

### Example 2

Example 2 was performed by following the process shown in FIG. 3.

Si nanoparticles having average particle size of 25 nm were compressed at 700 MPa in vacuum using a pellet forming machine without removing the spontaneous oxide film to form them into a 12 nm-dia. disk-shaped pellet.

This pellet was heated to 750° C., and vacuuming was performed for 60 seconds with the temperature maintained at 750° C., and then a mixed gas of 20 vol % acetylene and 80 vol % nitrogen was fed to this pellet for one second. This cycle was repeated 300 times to allow carbon to deposit on the surface of Si nanoparticles. The temperature was then increased to 900° C. and maintained at that level for 120 minutes as heat treatment to increase the crystallinity of the carbon. A composite of silicon and carbon was thus obtained.

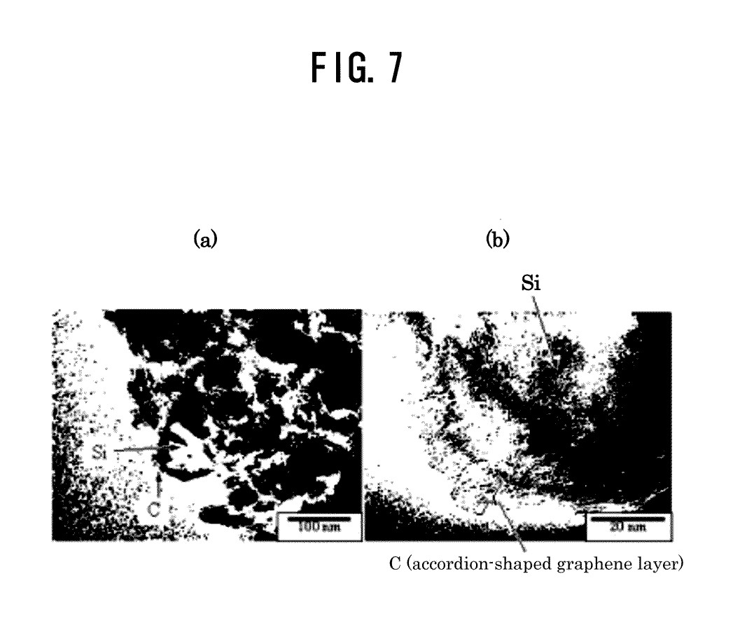

FIG. 7 is a view showing transmission electron microscopic images of the composite obtained in Example 2, where (a) is the image observed at a low magnification, and (b) is the image observed at a high magnification. From the low-magnification image shown in FIG. 7 (a), it is apparent that carbon has tightly deposited on the surface of Si particles. From the high-magnification image shown in FIG. 7 (b), it is confirmed that the network surface of the carbon having deposited on the surface of Si particles is not laminated in parallel to the surface of Si particles, but laminated in an undulating manner. Namely, as illustrated in FIG. 3 (d), an accordion-state graphene layer is formed on the surface of Si particles.

The carbon content in the composite was found to be 29 mass % based on the result of measurement conducted after heat treatment was completed as in the case of Example 1.

### Example 3

Example 3 was performed by following the process shown in FIG. 4.

A mixed gas of 10 vol % acethylene and 90 vol % nitrogen was fed to an aggregate of Si nanoparticles having average particle size of 25 nm for 30 minutes while maintaining the temperature at 750° C., without removing spontaneous oxide film or forming the aggregate into a pellet, to allow carbon to deposit on the surface of the Si nanoparticles. The temperature was then increased to 900° C. and maintained at that level for 120 minutes as heat treatment to increase the crystallinity of the carbon. A composite of silicon and carbon was thus obtained.

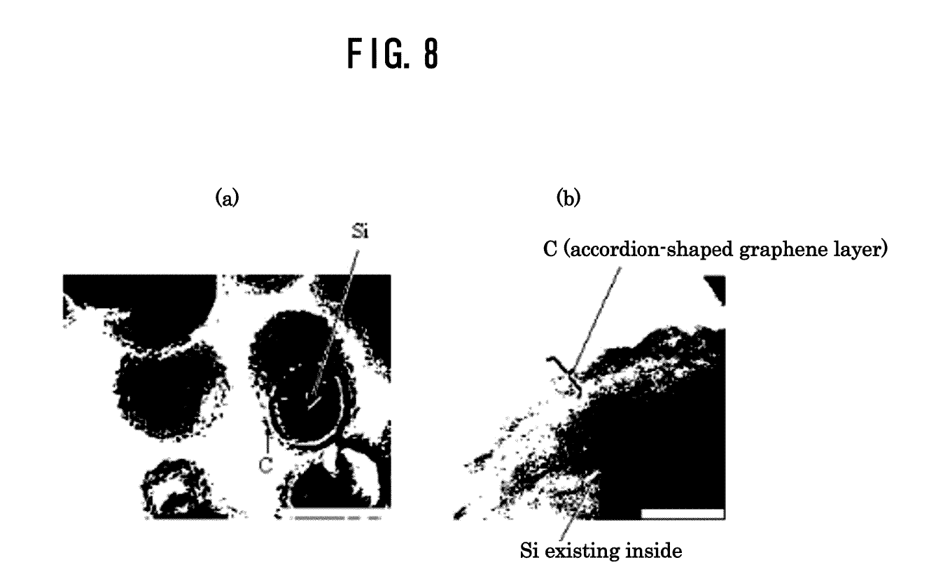

FIG. 8 is a view showing transmission electron microscopic images of the composite obtained in Example 3, wherein (a) is an image observed at a low magnification, and (b) is an image observed at a high magnification. From the low-magnification image shown in FIG. 8 (a), carbon is found to have deposited on the surface of Si particles. From the high-magnification image shown in FIG. 8 (b), it is confirmed that the network surface of the carbon having deposited on the surface of Si particles is not laminated in parallel to the surface of Si particles, but laminated in an undulating manner. Namely, as illustrated in FIG. 4 (c), an accordion-state graphene layer is formed on the surface of the Si particles. The carbon content in the composite was found to be 20 mass % based on the result of measurement conducted after heat treatment was completed as in the case of Example 1.

### Comparative Example 1

By subjecting Si nanoparticles having average particle size of 60 nm to heat treatment at 900° C. for 200 minutes in an air atmosphere, the thickness of the SiO₂ layer that had existed on the surface of the Si nanoparticles was further increased to form Si particles on whose surface SiO₂ was formed (hereinafter referred as “Si/SiO₂ particles”).

Then, as in the case of Example 1, the Si/SiO₂ particles were compressed at 700 MPa in vacuum using a pellet forming machine to form them into a disk-shaped pellet having diameter of 12 nm. An excessive amount of polyvinyl chloride (PVC) was placed on the molded pellet, heat treatment was performed at 300° C. for one hour, and the gaps among Si/SiO₂ particles were impregnated with the liquefied PVC. Then by performing heat treatment at 900° C. for 60 minutes, the pitches were carbonized completely. By then agitating it in a 0.5 mass % hydrofluoric acid solution for 90 minutes, the SiO₂ layer on the surface of the Si/SiO₂ particles was dissolved. By performing heat treatment at 900° C. for 120 minutes once again, a composite was obtained.

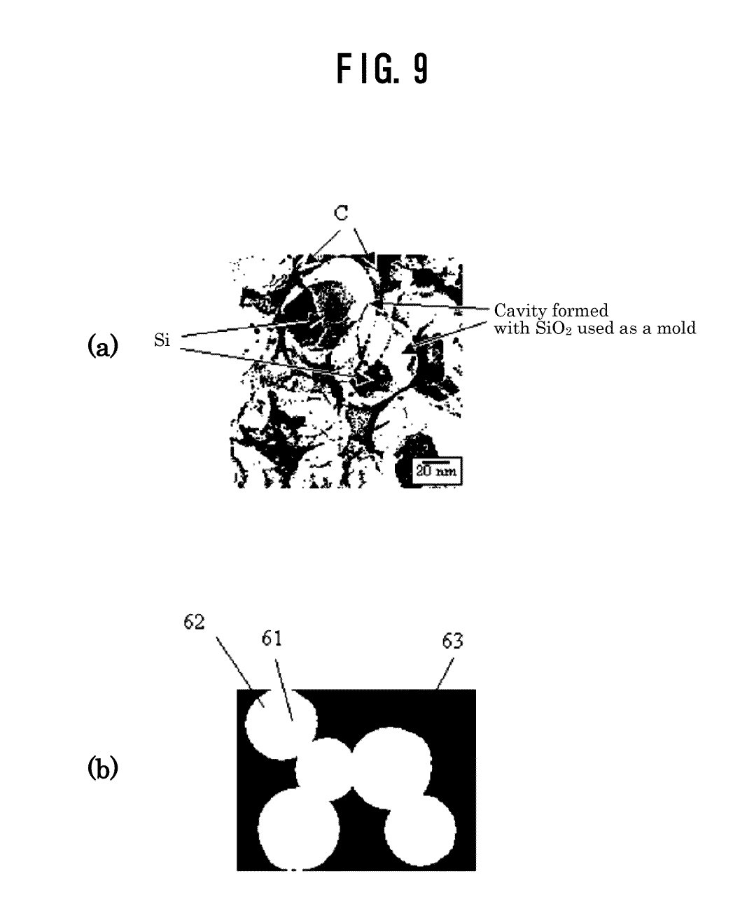

FIG. 9 is a view showing transmission electron microscopic images of the composite fabricated in Comparative Example 1, wherein (a) shows the image, and (b) is the illustration of that image. This image shows that a space 62 for buffering volume expansion that occurs at the time of charging is formed around the Si particle 61 by a housing body 63, which is made of carbon.

With the fabrication method in Comparative Example 1, the Si/SiO₂ ratio of Si/SiO₂ particles was found in the same manner as Example 1. SiO₂ having a volume approximately 3.2 times the space occupied by Si was found to have existed. In other words, with the composite obtained in Comparative Example 1, a space allowing Si volume expansion of up to 4.2 times is considered to exist around Si. In this way, the composite in Comparative Example 1 can buffer the volume expansion that occurs at the time of charging by the space formed with the SiO₂ layer serving as a mold. Namely, by the formation of this space, the volume expansion of up to four times the space occupied by Si can be buffered. However, unlike Examples 1 to 3, the image in FIG. 9 shows that there are no other spaces than those formed with SiO₂ serving as a mold, and the cavities among Si/SiO₂ particles are considered to have been filled with carbon. Consequently, if the buffer space around the Si nanoparticles increases to larger than the Si volume expansion at the time of charging, the composite structure is assumed to collapse.

By using the composites fabricated in Examples 1 to 3 and Comparative Example 1, negative electrodes for lithium-ion batteries were manufactured, and their charge characteristics were examined.

Using the composites fabricated in Examples 1 to 3, electrodes were manufactured by following the procedure shown below. The composite, carbon black (DENKA BLACK, Denki Kagaku Kogyo Kabushiki Kaisha), 2 mass % carboxymethylcellulose (CMC) (DN-10L, CMC DAICEL), and 48.5 mass % styrene-butadiene rubber (SBR) (TRD2001, JSR) were mixed so that the mixing ratio in weight of the composite, carbon black, CMC, and SBR became 67:11:13:9 after drying. This mixed solution was applied to a copper foil using a 9-m·inch applicator, dried at 80° C. for one hour, and then cut out into a 15.95 mm-diameter circle to manufacture an electrode.

The electrode thus manufactured was dried in vacuum at 120° C. for six hours in a pass box built in a glowe box, and then integrated into a coin cell (2032-type coin cell, Hohsen Corp.) in the glowe box in an argon atmosphere. In this case, metallic lithium was used as a counter electrode, 1M-LiPF₆ solution (1:1 mixed solvent of ethylene carbonate (EC) and diethyl carbonate (DEC)) was used as an electrolyte, and a polypropylene sheet (Cell Guard #2400) as a separator. By performing constant-current charge-discharge using the manufactured coin cell within the potential range of 0.01 to 1.5 V (v.s. Li/Li⁺), electrochemical performance of the sample was measured.

Using the composite fabricated in Comparative Example 1, an electrode was manufactured by following the procedure shown below. The composite in Comparative Example 1 and an n-methyl-2-pyrolydone solution (KF polymer (#1120), KUREHA) of polyvinylidene fluoride (PVDF) were mixed, the slurry was applied to a copper foil and dried, and the foil was cut out in a circular form having diameter of 16 mm to be used as an electrode. In this case, the ratio in weight of the composite and the PVD was maintained at 4:1. In this electrode, metallic lithium was used as a counter electrode of this electrode, a 1M-LiPF₆ solution (1:1 mixed solvent of ethylene carbonate (EC) and diethyl carbonate (DEC)) was used as an electrolyte, and a polypropylene sheet (Cell Guard #2400) was used as a separator. By performing constant-current charge-discharge using the manufactured coin cell within the potential range of 0.01 to 1.5 V (v.s. Li/Li⁺), electrochemical performance of the sample was measured.

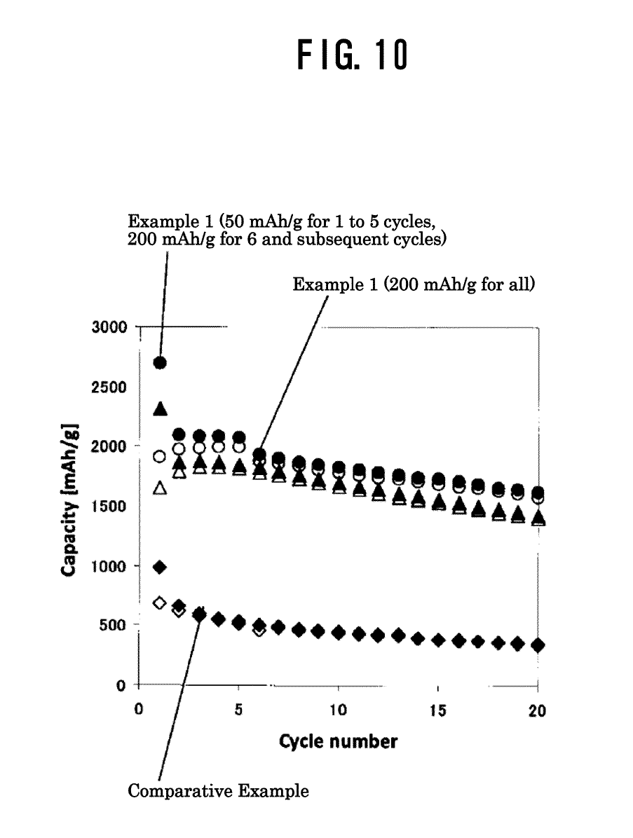

FIG. 10 is a chart showing the charge-discharge characteristics in Example 1 and Comparative Example 1. The horizontal axis represents cycle number, and the vertical axis represents capacity (mAh/g). Each of the data plotted with Δ, ▴, ◯, and shows the case of the electrodes manufactured using the composite in Example 1, whereas each of the data plotted with ⋄ and ♦ shows the case of the electrode manufactured using the composite in Comparative Example 1. The values in each data shown by blacked-out symbols such as ▴, , and ♦ represent values when lithium is inserted (hereinafter referred to as charge), whereas those in each data shown by hollow symbols such as Δ, ◯, and ⋄ represent values when lithium is extracted (hereinafter referred to as discharge). With each data plotted with ◯ and , the current density is 50 mA/g up to five cycles, and current density is 200 mA/g for six and subsequent cycles, whereas each data plotted with Δ, ▴, ⋄ and ♦ is the case where the current density is 200 mA/g for all the cycles.

FIG. 10 shows that if charge-discharge is measured at current density of 50 mA/g in Example 1, the capacity of the first cycle was 1900 mAh/g, and that if charge-discharge is measured at current density of 200 mA/g, the capacity of the first cycle was 1650 mAh/g.

In addition, even if charge-discharge was performed repetitively, decrease in capacity was small, with no decrease in capacity observed in a period from the second to the fifth cycles, where charge-discharge was performed at current density of 50 mA/g. Furthermore, even if charge-discharge was repeated at the current density of 200 mA/g from the first cycle, the capacity of the 20th cycle was confirmed to be 1400 mAh/g, which accounts for 85% of the capacity of the first cycle.

Meanwhile, when charge-discharge was measured at the current density of 200 mA/g in Comparative Example 1, the capacity even at the first discharge was as small as 691 mAh/g. In addition, with the repetition of charge-discharge cycles, the capacity decreased significantly, the capacity of the 20th cycle being as low as 341 mAh/g, which was 49% or less of the first discharge volume.

Comparison between Example 1 and Comparative Example 1 shows that much greater charge-discharge capacity can be obtained in Example 1.

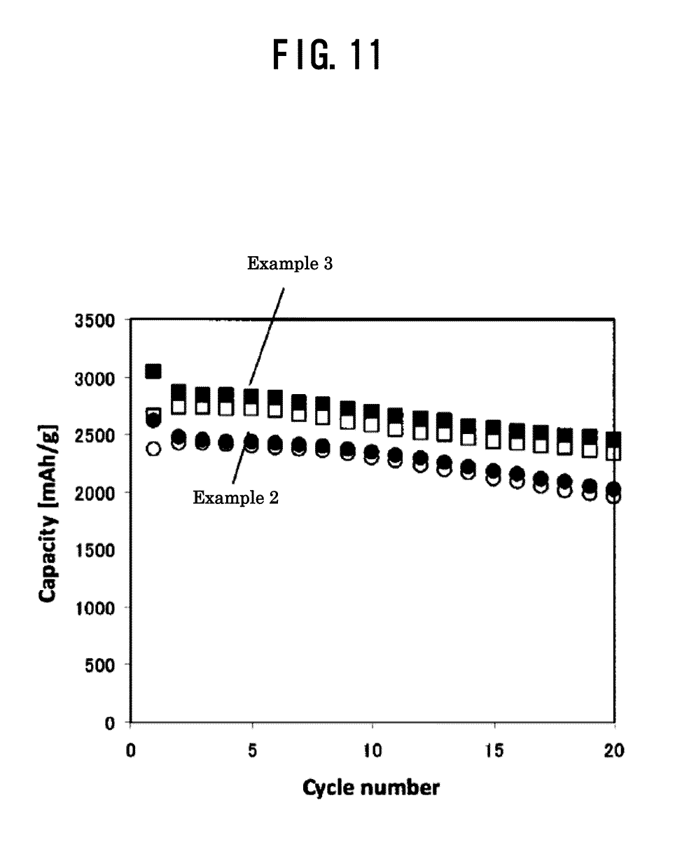

FIG. 11 is a chart showing the charge-discharge characteristics in Examples 2 and 3. The horizontal axis represents the cycle number, and the vertical axis represents capacity (mAh/g). Each data plotted with ◯ and represents the case of the electrode manufactured using the composite in Example 2, and each data plotted with □ and ▪ represents the case of the electrode manufactured using the composite in Example 3. The values plotted with blacked-out symbols represent those obtained at the time of charge, whereas the values plotted with hollow symbols represent those obtained at the time of discharge. The current density was 200 mA/g in all the cases.

It is apparent from the figure that larger charge-discharge capacity is maintained in Examples 2 and 3 compared to Example 1. In addition, decrease in capacity was found to be small even if charge-discharge cycles are repeated.

As shown in FIG. 7, with the composite in Example 2, since the accordion-shaped carbon walls had some flexibility, Si particles were not detached from the carbon walls even if change in Si volume occurred as a result of charge-discharge, thus allowing charge-discharge cycles to be repeated.

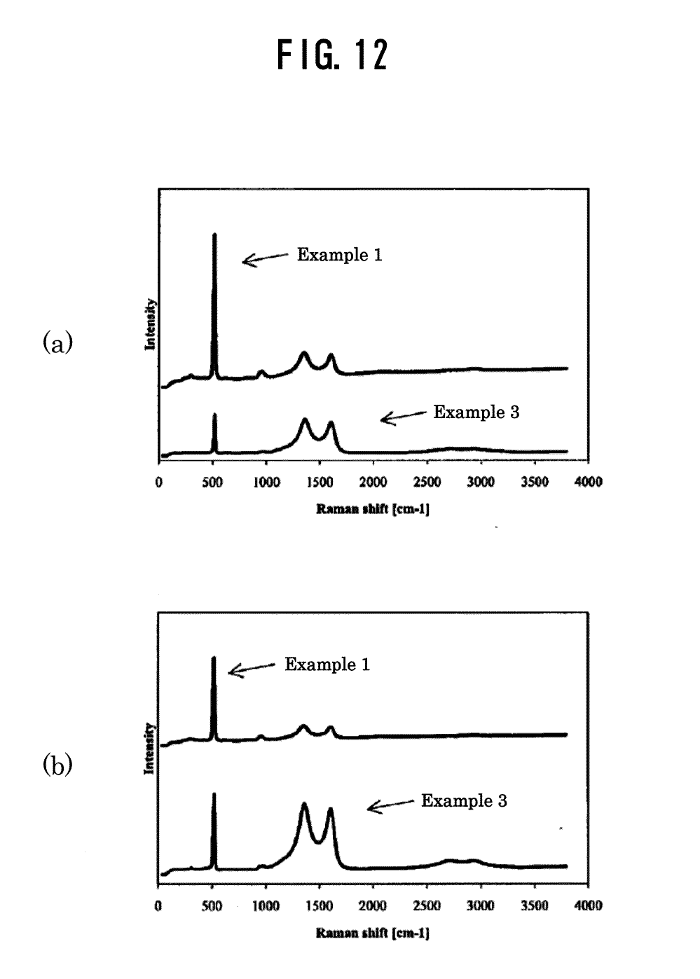

FIG. 12 provides charts showing the results of the Raman measurement of the composites fabricated in Examples 1 and 3, wherein (a) represents actual measurement data itself, and (b) represents the results of adjustment made to allow comparison between both spectra at the Si intensity having a peak at approximately 500 cm⁻¹. Of the spectra shown in FIG. 12, the first spectrum shown on the upper side in FIG. 12 is the Raman spectrum of the composite fabricated in Example 1. The second spectrum shown on the lower side in FIG. 12 is the Raman spectrum of the composite manufactured in Example 3.

In either one of the spectra, a peak appeared around 1300 cm⁻¹ and 1600 cm⁻¹. Since there is a peak around 1600 cm⁻¹, the carbon in the carbon layer is confirmed to have a graphene sheet structure.

The composite in Example 1 was observed under a transmission electron microscope (TEM), and confirmed to have a partially laminated graphite structure.

Regarding Examples 2 and 3, charge-discharge cycles were repeated for several dozen times, but no structural degradation of the composites was observed under TEM and SEM.

Examples 1 to 3 and Comparative Example 1 were described above, but the present invention is not limited to these examples. Even if various conditions are changed, if the average Si particle diameter is increased to approximately 60 nm or 120 nm, for example, in the fabrication method shown in FIG. 4, the similar results are assumed to be obtained. In addition, even with the Si particles having average particle size of 25 nm, even if conditions other than those shown in Example 3 are used, various types of source gases such as propylene and benzene may be used for carbon layer, for example, the similar results are assumed to be obtained.

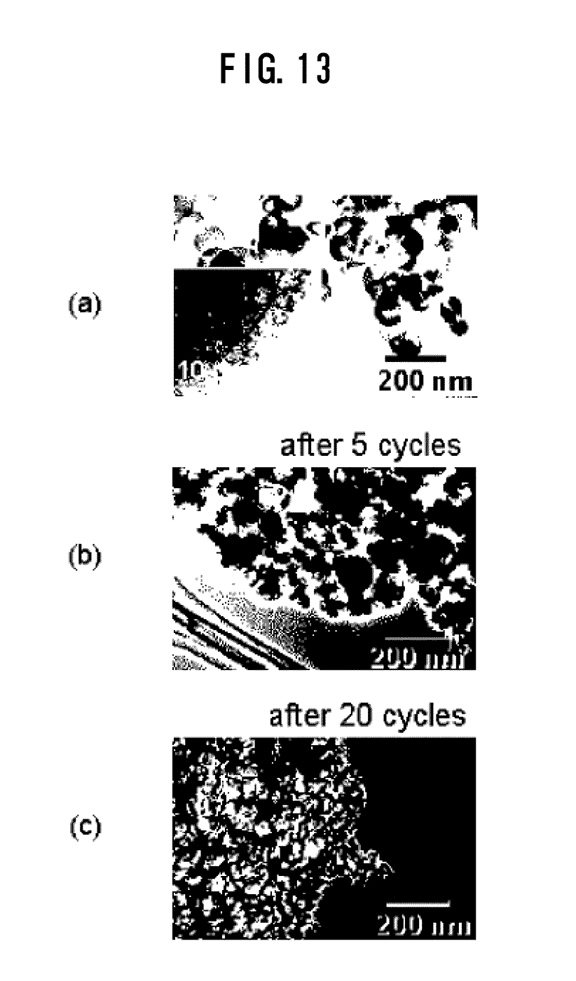

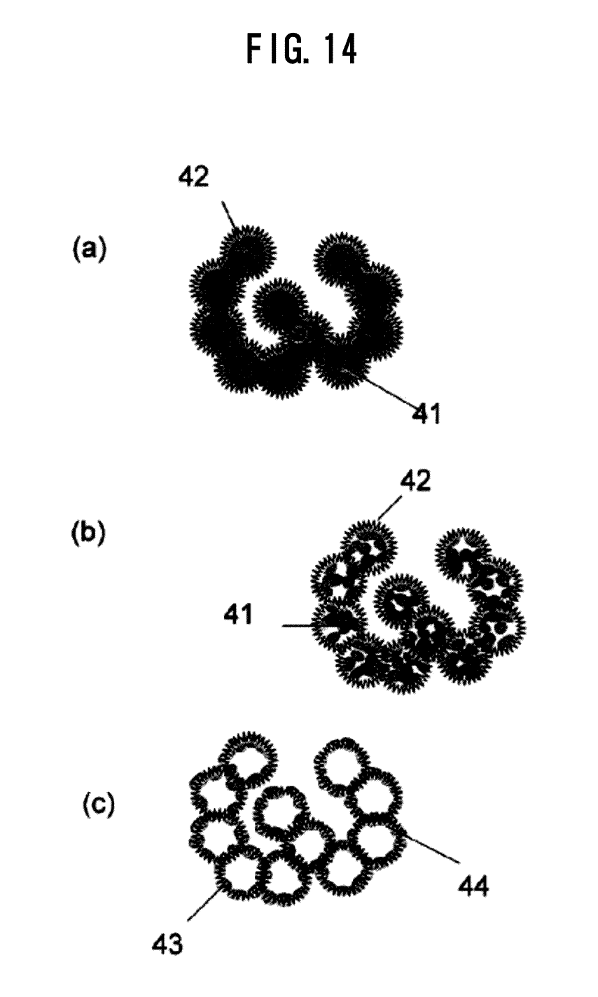

TEM images were examined in detail to find what kind of structural change had occurred to the composite when a lithium-ion battery manufactured using the composite obtained in Example 3 was charged/discharged. FIG. 13 is a TEM image of the composite in Example 3 used as a negative electrode material for a lithium-ion battery, wherein (a), (b), and (c) are TEM images of the composite before charge-discharge cycle, after 5 cycles, and after 20 cycles respectively, and the views in FIG. 14 are the illustrations of each image in FIG. 13.

As shown in FIGS. 13 (a) and 14 (a), Si nanoparticles 41 are continuous before charge-discharge, and a carbon nano-layer 42 having thickness of approximately 10 nm is formed on the surface. After charge-discharge was repeated for 5 cycles, the Si nanoparticles 41 were found to have been miniaturized as shown in FIGS. 13 (b) and 14 (b). After charge-discharge was repeated for 20 cycles, the Si particles were further miniaturized and integrated into the carbon framework 44 as shown in FIGS. 13 (c) and 14 (c) (sign 43). In other words, the miniaturized Si particles 43 are found to be forming a 3D network along the inner side of the frame network of the carbon shown by sign 44. Consequently, the carbon coating is considered to be forming a conductive path.

In this case, it is assumed that the carbon frame functions as a means to transport electrons, the region surrounded by Si particles inside the carbon frame functions as a space for storing Li, and the region surrounded by the carbon frame and not surrounded by Si particles functions as a space for transporting Li.

When the charge-discharge cycles were repeated 20 times or less, the capacity was as high as 2500 mAh/g, which is approximately 7 times the theoretical value of graphite of 372 mAh/g.

### Example 4

As Example 4, a composite was synthesized by the fabrication method shown in FIG. 4 under the conditions different from the synthesis conditions of Example 3. Without removing the spontaneous oxide film, and without forming an aggregate of Si nanoparticles having average particle size of 25 nm into a pellet, its temperature was increased to 750° C. in vacuum, vacuuming was performed for 60 seconds while the temperature was maintained at 750° C., and then a mixed gas of 20 vol % acetylene and 80 vol % nitrogen was fed for one second. This cycle was repeated 300 times to allow carbon to deposit on the surface of Si nanoparticles. The composite obtained in this way is represented as “Si/C.” The carbon content in Si/C was found to be 21 wt %.

The temperature was then increased to 900° C. in vacuum and maintained at that level for 120 minutes in vacuum as heat treatment to increase the crystallinity of the carbon. A composite of silicon and carbon was thus obtained. The composite in this state is represented as “Si/C (900).” With Si/C (900), the thickness of the carbon layer was confirmed to be approximately 10 nm, and the orientation of the carbon layer was confirmed to be rough on the TEM image. Note that the carbon content in the Si/C decreased slightly to 19 wt % by the heat treatment performed at 900° C.

Heat treatment was then performed under two temperature conditions, namely at 1000° C. and 1100° C., while Ar gas was being fed. The sample obtained by heat treatment performed at 1000° C. is represented as “Si/C (1000),” and the sample obtained by heat treatment performed at 1100° C. is represented as “Si/C (1100).”

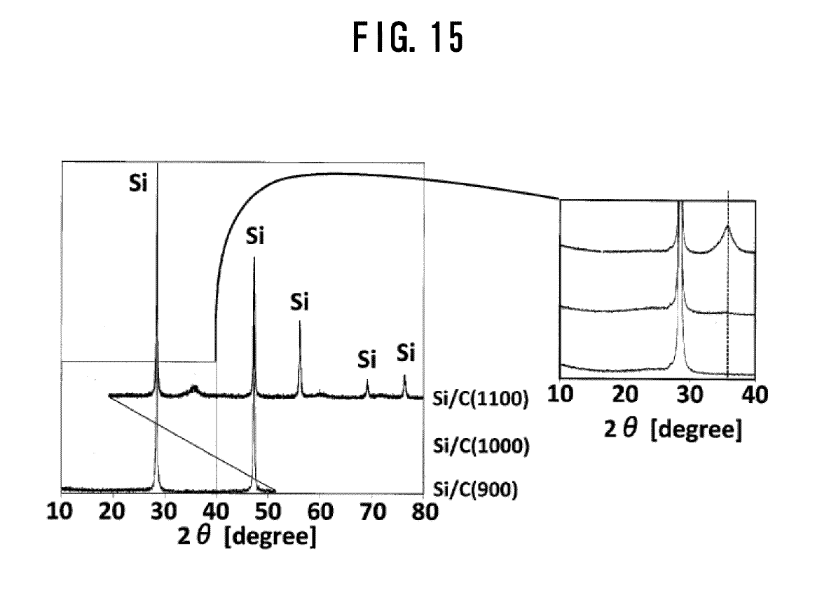

FIG. 15 is a chart showing the XRD patterns of crystalline structure of the samples, Si/C (900), Si/C (1000), and Si/C (1100). The horizontal axis represents diffraction angle 20 (degree), and the vertical axis represents X-ray diffraction intensity. FIG. 15 shows that no spectra due to carbon atoms were observed, meaning that the carbon had low crystallinity. With the Si/C (1100) sample, crystalline SiC was found to have been formed.

By using the composite obtained in Example 4, a negative electrode for lithium-ion batteries was manufactured and its charge characteristics were examined, in the same manner as Examples 1 to 3.

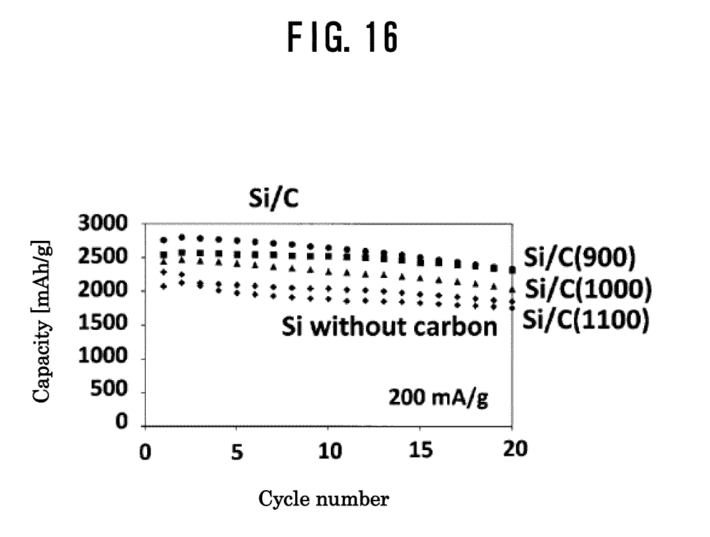

FIG. 16 is a chart showing the charge-discharge characteristics in Example 4. For a comparison purpose, the data obtained by using uncoated Si nanoparticles is also presented. The data plotted with the circle () is that of Si/C, the data plotted with the square (□) is that of Si/C (900), the data plotted with the triangle (▴) is that of Si/C (1000), and the data plotted with the diamond (♦) is that of Si/C (1100).

Since all of the Si/C composites contain carbon by approximately 19%, the theoretical capacity of the composites is supposed to be smaller than that of pure Si. However, all of the samples were found to exhibit the charge-discharge capacity the same as or higher than that of Si nanoparticles, because carbon coating allowed the amount of Si connected to conductive paths to increase.

As shown in FIG. 16, the Si/C sample exhibited the highest initial Li discharge capacity, namely 2750 mAh/g. If the capacity of carbon is assumed to be 372 mAh/g, Si is considered to have been alloyed with Li, forming Li_{3.5}Si composition, which is a state close to the theoretical capacity composition (Li₁₅Si₄) of Si. With the Si/C sample, however, with the increase in cycles, the capacity gradually decreased, the capacity after 20 cycles being approximately the same as that of Si/C (900). Meanwhile, with the Si/C (900) sample wherein the crystallinity of carbon had been increased by heat-treating Si/C at 900° C., the capacity retaining ratio improved although the initial capacity was lower than that of Si/C. Although Si expansion is suppressed slightly due to strengthened carbon structure, thus causing the capacity to decrease, the carbon contracted slightly by heat treatment performed at high temperature, thereby enhancing the adhesion with Si, and consequently the capacity retaining ratio is thus considered to have improved.

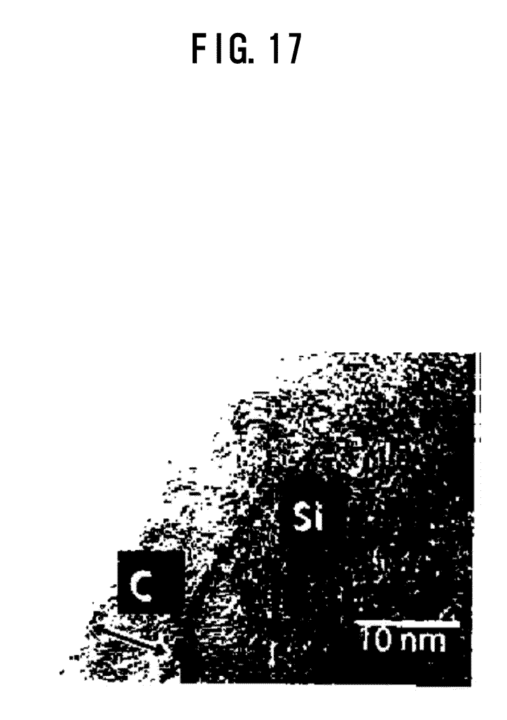

With the Si/C (1100) sample obtained by heat treatment performed at higher temperature, the capacity retaining ratio is as high as that of Si/C (900), but its capacity is lower than the sample wherein carbon coating was not performed, because SiC was generated by heat treatment. FIG. 17 is a TEM image of Si/C (900), which has high capacity and good cycle characteristics. On the surface of Si nanoparticles, an approximately 10 nm-thick carbon layer is found to have deposited tightly, and the carbon hexagonal net surface within the carbon layer was found to have oriented in a random fashion.

From the above, as a result of covering the surface of Si nanoparticles with carbon, preferably covering the entire surface, charge is considered to have been completed without losing electrical contact of Si even if Si expanded.

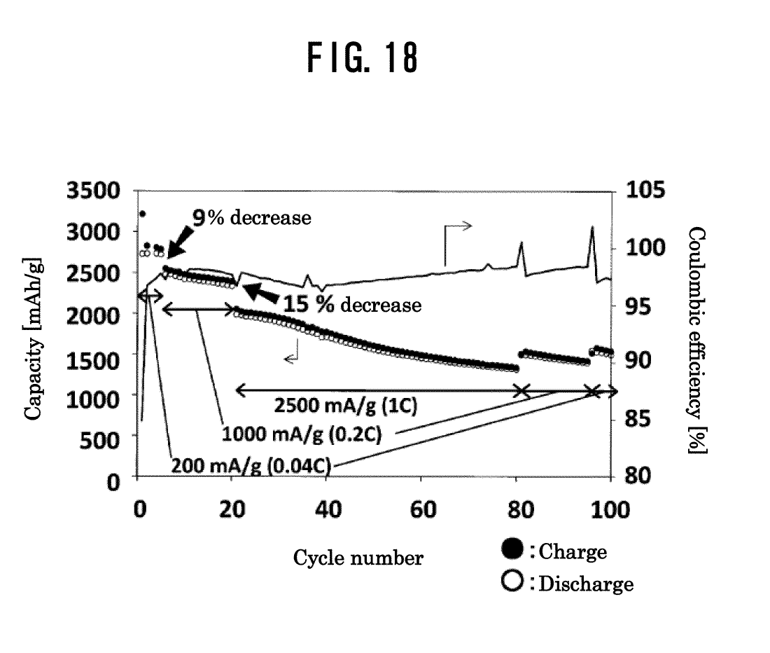

Then, using the Si/C (900) sample obtained by performing heat treatment at 900° C., current density in charge-discharge was varied to find its cycle and rate characteristics. FIG. 18 shows the charge-discharge characteristics of the Si/C (900) sample obtained by performing heat treatment at 900° C. The horizontal axis represents cycle number, left vertical axis represents capacity (mAh/g), and right vertical axis represents coulombic efficiency (%)

The current density was maintained at 200 mA/g (0.04C) up to 4 cycles, it was then maintained at 1000 mA/g (0.2C) up to 20 cycles, at 2500 mA/g (1C) from 21 to 80 cycles, at 100 mA/g (0.2C) from 81 to 94 cycles, and at 200 mA/g (0.04C) thereafter.

The discharge capacity at the first cycle was as high as 2730 mAh/g, which accounted for 94% of the theoretical capacity of 2900 mAh/g. The discharge capacity at the fourth cycle showed the decrease from the initial capacity only by 9%, and up to the 20th cycles, the capacity was found to have decreased only by 15% and good rate characteristics were also maintained. Furthermore, even if charge-discharge was performed in the 21st cycle at 1C, namely at the current density allowing full charge to be completed in one hour, the capacity remained at approximately 2000 mAh/g, and decreased subsequently. Even after 100 cycles, the capacity remained at 1500 mAh/g, meaning the decrease in capacity was small.

Structural change in the TEM image due to charge-discharge was examined. It was confirmed that the Si particles had been miniaturized by charge-discharge, and combined with carbon at nano level, thereby forming a branched structure.

It was found from the above that since the conductive paths of Si are maintained even if the volume of Si changes repeatedly, high capacity and long life can be achieved, which is hardly achievable in the prior art.

### Example 5

The temperature of the aggregate of Si nanoparticles having average particle size of 60 nm was increased to 750° C. in vacuum, vacuuming was performed for 60 seconds while the temperature was maintained at that level, and then a mixed gas of 20 vol % acetylene and 80 vol % nitrogen was fed for one second. This cycle was repeated 300 times. As a result, carbon was found to have deposited on the surface of Si nanoparticles. The temperature was then increased to 900° C. while the state of vacuum was maintained, and the temperature was maintained at that level for 120 minutes as heat treatment to enhance the crystallinity of the carbon.

A composite wherein Si nanoparticles were covered with carbon was obtained as described above. The composite was heated to 1400° C. in an air atmosphere to allow complete oxidation to occur, and based on the measurement of change in weight, the Si/C ratio in the composite was calculated. The carbon content in nano-Si/C was 19 wt %. The theoretical capacity of nano-Si/C can be calculated to be 2970 mAh/g from the Si/C ratio, provided that the theoretical capacity of Si was assumed to be 3580 mAh/g and that of C to be 372 mAh/g.

By using the fabricated composite, a negative electrode for lithium-ion batteries was manufactured in the same manner as Examples 1 to 3, except that the electrode assembly was manufactured so that the thickness of the negative electrode became 15 μm. In the same way as Examples 1 to 3, electrochemical performance was measured.

As a result of observing the TEM image of the nano-Si/C composite fabricated, Si nanoparticles were found to be connected, forming a 3D network structure, and the surface of the Si nanoparticles was found to be covered with nano-sized carbon layer having average particle size of 10 nm. The carbon layer was not in a normal laminated structure, but in a state where the orientation of its graphene sheet was rather random.

### Comparative Example 2

As Comparative Example 2, a Si/C composite was fabricated using micro-sized Si microparticles having average diameter of 1 μm, and an electrode was manufactured using the composite.

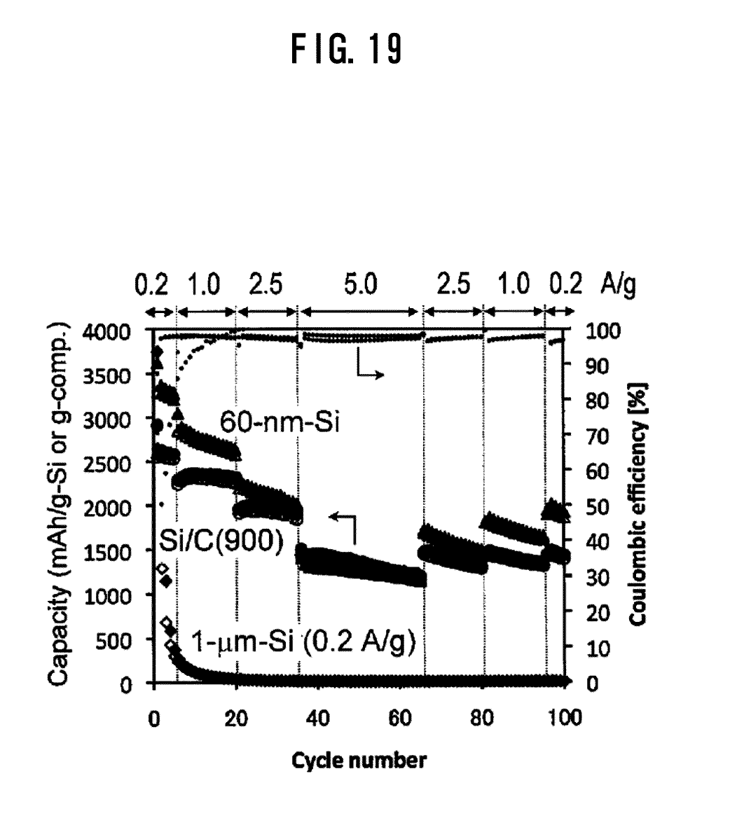

FIG. 19 is a chart showing the charge-discharge characteristics of the case where the nano-Si/C composite obtained in Example 5 was used. The horizontal axis represents cycle number, left vertical axis represents capacity (mAh/g), and right vertical axis represents coulombic efficiency (%). Current density was made to vary between 0.2 to 5 A/g for Si nanoparticles and the Si/C composite in Example 5. Whereas the capacity decreased rapidly by the time 20 cycles were completed with Si microparticles, the Si nanoparticles and Si/C composite exhibited high value even after 100 cycles, specifically the value higher than 1300 mAh/g. The fact that Si has smaller particle size has significant meaning to ensure better cycle characteristics.

The first Li discharge capacity of Si nanoparticles was 3290 mAh/g, which is 91% of the theoretical value. With the Si/C composites, it was 2250 mAh/g, 88% of the theoretical value. In the first charge-discharge cycle where current density is small, the existence of carbon has no effect on the charge characteristics of the Si/C composite. However, up to the subsequent 35 cycles, the capacity of the Si/C composite remained more stable than that of Si nanoparticles. When charge-discharge was performed at current density as high as 5 A/g up to subsequent 65 cycles, the capacity of the Si/C composite was higher than that of the Si nanoparticles.

To achieve better cycle and rate characteristics of the Si/C composite, a continuous carbon network is necessary to supply current to the Si nanoparticles in the initial stage. Such carbon network is formed as a result of dynamic change in the structure of the Si/C composite while cycles are repeated. However, such effect was lost after 66 and subsequent cycles, which is considered to have occurred because the carbon network was lost.

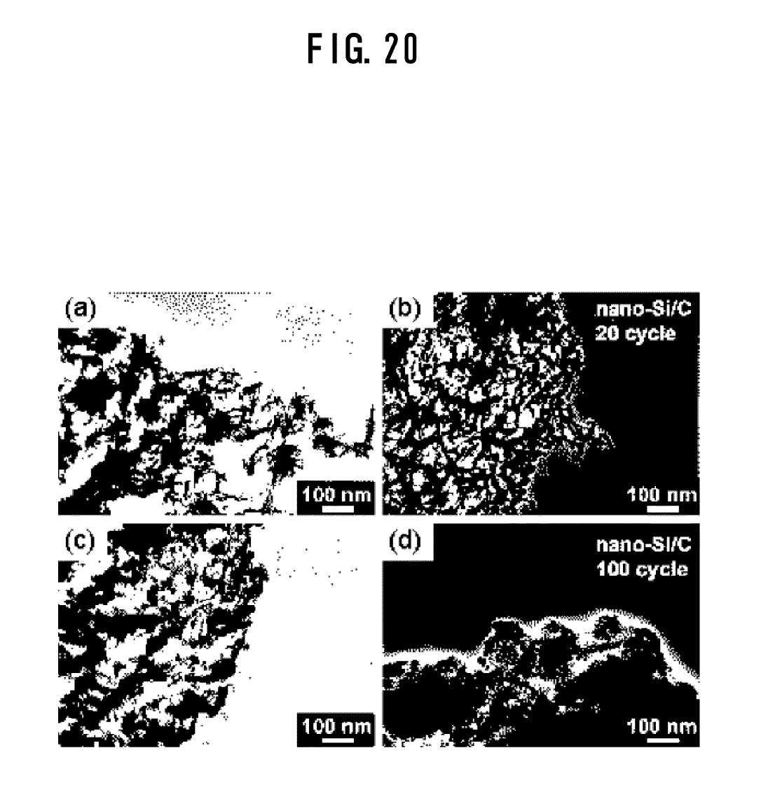

FIG. 20 (a) is a TEM image of the Si nanoparticles in the electrode after 20 cycles. The Si nanoparticles, which were in a spherical shape before charge-discharge, have changed their structure drastically into a dendrite structure, namely multi-branching tree-like crystal structure, by being subjected to 20 charge-discharge cycles. (c) is a TEM image of the Si nanoparticles in the electrode after 100 cycles. The image shows that the multi-branching tree-like crystal structure has been lost, and a completely anarchic aggregate has appeared. (b) is a TEM image of the Si/C composite in the electrode after 20 cycles. When the Si nanoparticles are covered with carbon, a multi-branching tree-like crystal structure is found to have been formed as in the case in (a) where there is no carbon. Consequently, the structure of the carbon layer that was covering the Si nanoparticles before charge-discharge must have changed significantly as the structure of the Si nanoparticles must have done, and been taken into multi-branching tree-like crystal structure. (d) is a TEM image of the Si/C composite in the electrode after 100 cycles. Note that the TEM image of the Si/C composite after the composites were fabricated was similar to FIG. 13 (a).

The initial state of the Si/C composite differs greatly from the state after charge-discharge has been repeated. By repeating charge-discharge, its structure changes into a dendrite structure, namely multi-branching tree-like crystal structure, and after 100 cycles, a completely anarchic state is reached.

From FIG. 20 (b), Si and carbon were found to be in dendrite state and coexist uniformly within the frame network. The impedance of the dendrite was measured to find that it had low charge transport resistance.

From the above, a frame network in dendrite-like structure was found to have been obtained after the carbon nano-layer was formed on Si nanoparticles.

Whether charge-discharge can be performed without breaking the dendrite frame network was investigated. Based on the capacity at the time of initial lithium insertion shown in FIG. 19, the Si in Si/C composite is estimated to have expanded to 3.7 times the initial volume. Such a large volume expansion is considered to be one of the causes of great structural change. To prevent such structural change, a restriction was put for the capacity not to exceed 1500 mAh/g when Li was inserted, and charge-discharge was repeated using the Si/C composite. The value 1500 mAh/g corresponds to Li_{1.9}Si. Under this condition, volume expansion of Si, following the insertion of Li, can be suppressed to approximately twice the initial volume.

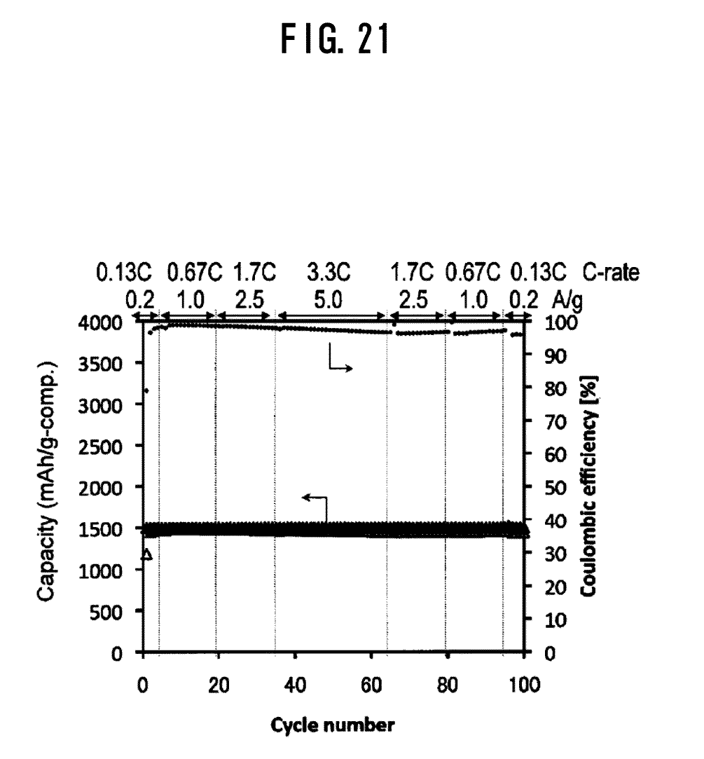

FIG. 21 is a chart showing the cycle characteristics of charge-discharge capacity obtained when restriction was put so that the capacity did not exceed 1500 mAh/g. As shown in the chart in FIG. 21, the current density was varied depending on the cycle number as follows: 0.2 A/g, 1 A/g, 2.5 A/g, 5 A/g, 2.5 A/g, 1 A/g, and 0.2 A/g. The horizontal axis represents cycle number, left vertical axis represents capacity (mAh/g), and right vertical axis represents coulombic efficiency (%).

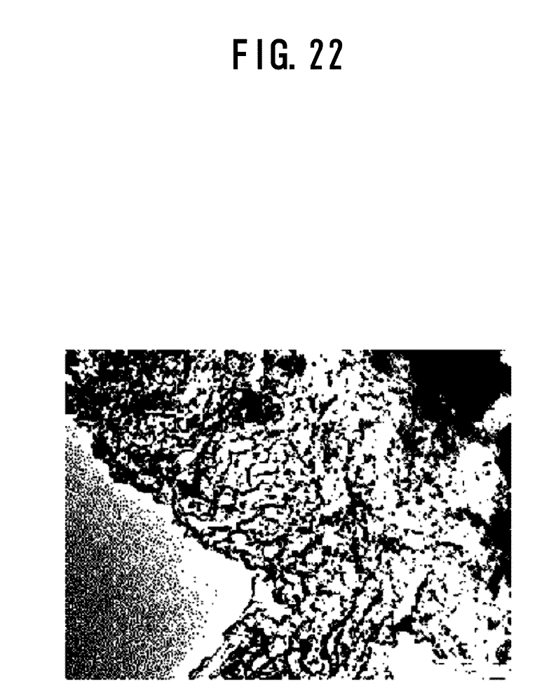

Even when the current density was 5 A/g, extremely high capacity, namely 1500 mAh/g, was maintained. The charge-discharge time at 5 A/g was as short as 18 minutes respectively, namely high-rate condition of 3.3C. In addition, the capacity of 1500 mAh/g is approximately four times as high as the conventional theoretical capacity of graphite electrode (372 mAh/g). FIG. 21 shows that the Si/C composite achieves high-capacity and high-rate characteristics. FIG. 22 is a TEM image of the Si/C composite after 100 cycles. FIG. 22 shows that dendrite structure remained.

From the above, it was found that by adjusting the current density, charge-discharge capacity as high as 1500 mAh/g can be maintained.

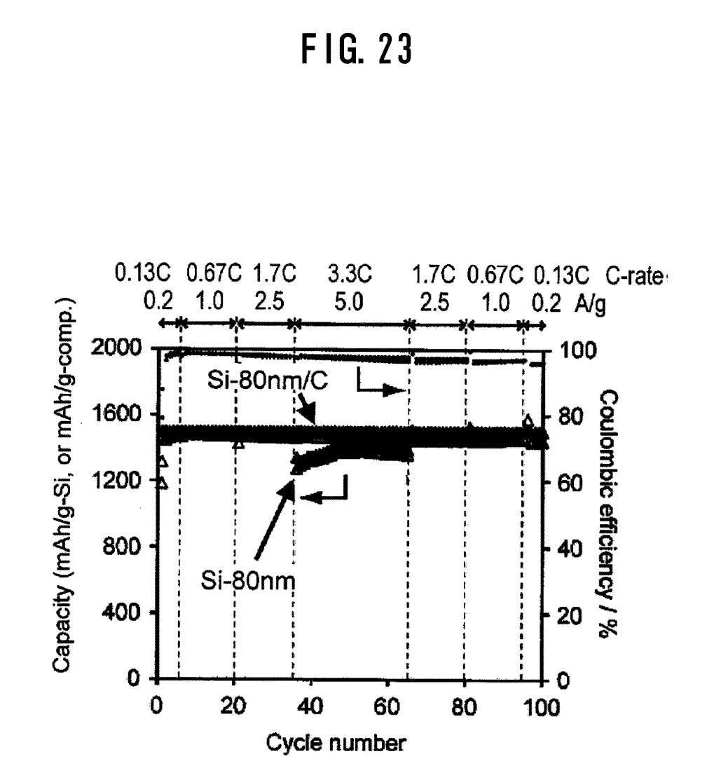

A composite was fabricated in the same manner by using Si nanoparticles having average particle size of 80 nm instead of Si nanoparticles having average particle size of 60 nm, and its charge-discharge characteristics were examined. As a result of observing its TEM image, the similar results were obtained. The current density was also adjusted as described previously. FIG. 23 is a chart showing the cycle characteristics of charge-discharge capacity when a restriction was put so that the capacity did not exceed 1500 mAh/g and the average particle size of the Si nanoparticles was 80 nm. Even when the number of times of charges-discharges reached 100 times, the capacity remained at 1500 mAh/g. For a comparison purpose, when a composite is not fabricated using Si nanoparticles having average particle size of 80 nm, the capacity of the Si nanoparticles decreased to slightly above 1200 once and then increased slightly again, but it remained smaller than that of the composite within the range where the current density was varied from 2.5 A/g to 5 A/g.

### Example 6

The composite in Example 6 was obtained by following the process shown in FIG. 4.

The temperature of Si nanoparticles (Nanostructured & Amorphous Materials Inc.) having particle size ranging from 20 to 30 nm and purity of 98% or higher was increased to 750° C. at the rate of 5° C./min. in vacuum without removing the spontaneous oxide film, vacuuming was performed for 60 minutes while the temperature was maintained at 750° C., and then a mixed gas of 20 vol % acetylene and 80 vol % nitrogen was fed for one second. This cycle was repeated 300 times to allow carbon to deposit on the surface of the Si nanoparticles. The temperature was then increased to 900° C. and maintained at that level for 120 minutes as heat treatment to enhance the crystallinity of the carbon. A composite of silicon and carbon was thus obtained.

By using the composite fabricated in Example 6, negative electrodes for lithium-ion batteries were manufactured with the types of binder varied, and their charge-discharge characteristics were examined. As the binders, CMC+SBR binder and Alg binder were used, and the electrode assemblies were manufactured as in the case of Examples 1 to 3.

In the case of the CMC+SBR binder, the electrode was manufactured in the same manner as Examples 1 to 3 described previously.

In the case of sodium alginate (Alg) binder, by using a 1 wt % Alg solution, the composite, carbon black (Denka Black, Denki Kagaku Kogyo Kabushiki Kaisha), and sodium alginate (Sodium alginate 500-600, Wako Pure Chemical Industries, Ltd.), a mixed liquor (slurry) was prepared so that the mixing ratio in weight of the composite, carbon black, and Alg became 63.75:21.25:15 after drying. Electrodes were then manufactured in the same manner as Example 1 to 3. The electrodes in Examples 1 to 4 were in a form of a 10 to 20 μm-thick sheet, but the electrodes in Example 6 were as thick as 40 to 70 μm.

The electrodes manufactured in this way were dried in vacuum in a pass box housed in a glowe box at 120° C. for six hours, and then embedded into a coin cell (2032-type coin cell, Hohsen Corp.) in the glowe box in argon atmosphere. Metallic lithium was used as a counter electrode, a 1M-LiPF₆ solution (a 1:1 mixed solvent of ethylene carbonate (EC) and diethyl carbonate (DEC)) was used as electrolyte, and a polypropylene sheet (Cell Guard #2400) was used as a separator. As the electrolyte, the one with vinylene carbonate (VC) added by 2 wt % was also prepared, in addition to the one described above.

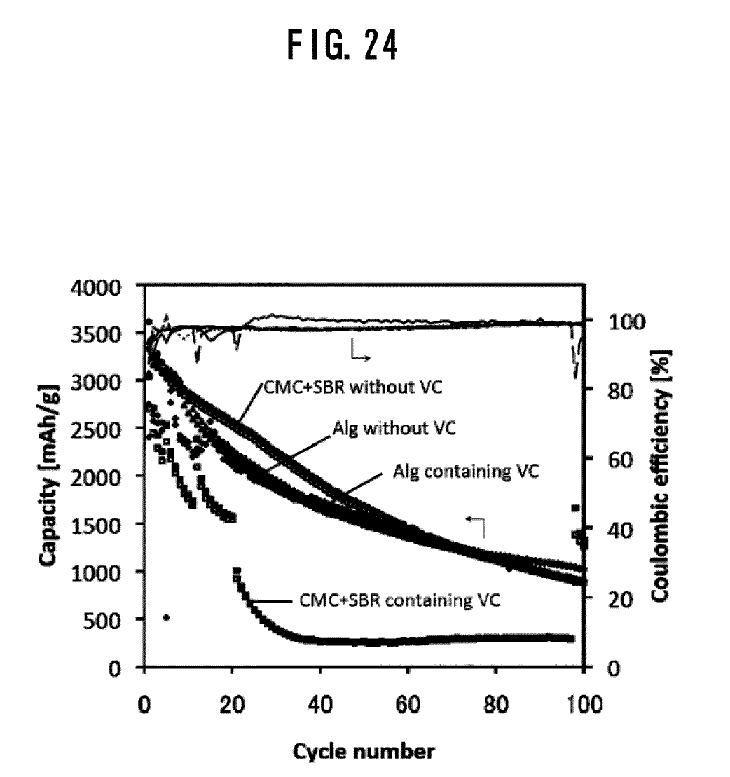

FIG. 24 is a chart showing the charge-discharge characteristics of Example 6. The horizontal axis represents cycle number, left vertical axis represents capacity (mAh/g), and right vertical axis represents coulombic efficiency (%). The data plotted with the squares (▪, □), that plotted with the circles (, ◯), that plotted with the triangles (▴, Δ), and that plotted with the diamonds (♦, ⋄) respectively represent the data of CMC+SBR binder with VC, that of CMC+SBR binder without VC, that of Alg binder with VC, and that of Alg binder without VC. The pieces of data plotted with blacked-out and hollow symbols respectively represent the capacity obtained when Li was inserted and that obtained when Li was extracted. The change in coulombic efficiency is shown by the polygonal line. The potential range of charge-discharge was from 0.01 to 1.5 V, and the current density was 200 mA/g.

When CMC+SBR binder not containing VC in the electrode was used, the capacity was approximately 2000 mAh/g or higher when the cycles were approximately 30 or less. Meanwhile, when Alg binder was used, the capacity was 2000 mAh/g or higher when the cycles were approximately 40 or less. With the increase of cycle number, the capacity decreased even if any of the binders was used, however, 1400 mAh/g was maintained although charge-discharge was repeated for 100 cycles. It was thus found that by using Alg binder, charge-discharge characteristics was improved.

When the CMC+SBR binder was used, the charge-discharge characteristics were found to decrease by adding VC to the electrolyte. In addition, the coulombic efficiency was found not to depend on whether VC was added to the electrolyte or not, and on the types of the binder, and found to come close to 100% when the number of times of charge-discharge increased.

### Comparative Example 3

As Comparative Example 3, electrodes were manufactured using Si nanoparticles, and their charge-discharge characteristics were examined.

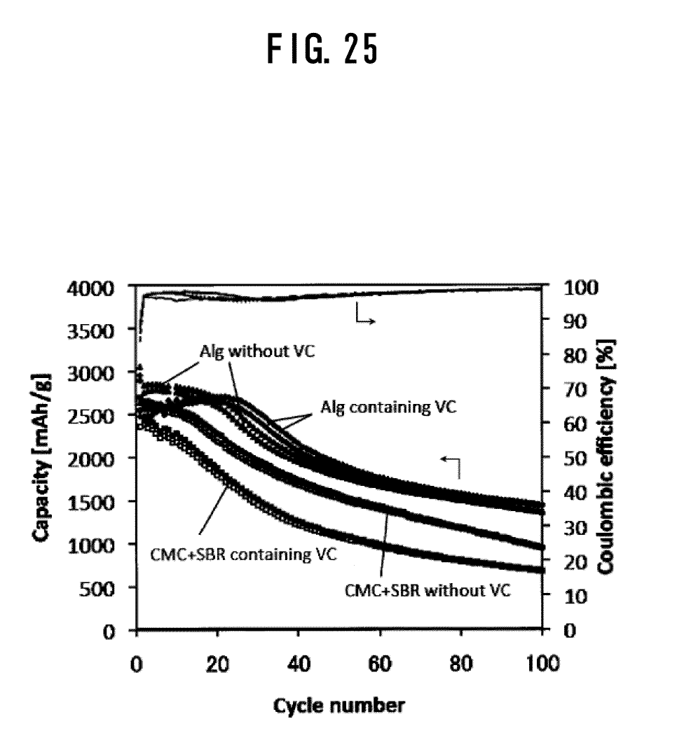

FIG. 25 is a chart showing the charge-discharge characteristics of Comparative Example 3. The horizontal axis represents cycle number, left vertical axis represents capacity (mAh/g), and right vertical axis represent coulombic efficiency (%). The data plotted with the squares (▪, □), that plotted with the circles (, ◯), that plotted with the triangles (▴, Δ), and that plotted with the diamonds (♦, ⋄) respectively represent the data of CMC+SBR binder with VC, that of CMC+SBR binder without VC, that of Alg binder with VC, and that of Alg binder without VC, and the pieces of data plotted with blacked-out and hollow symbols respectively represent the capacity obtained when Li was inserted and that obtained when Li was extracted. The change in the coulombic efficiency is represented by the polygonal line. The potential range of charge-discharge was from 0.01 to 1.5 V, and the current density was basically 200 mA/g, except when CMC+SBR binder was used with VC and after 21 and subsequent cycles, where the current density was 1000 mA/g.

In either of the cases where CMC+SBR binder was used and Alg binder was used, when charge-discharge was repeated 100 times, the capacity decreased to approximately 1000 mAh/g. When the number of times of charge-discharge was increased by covering the Si nanoparticles with carbon as in the case of Example 6, the capacity as high as approximately 1500 mAh/g was found to be maintained.

By adding VC to the electrolyte, characteristics were found to improve when CMC+SBR binder was used, but no improvement was confirmed when Alg binder was used.

[Effect of the Difference in the State of Existence of Carbon on the Charge-Discharge of Si Nanoparticles]

From the Examples and Comparative Examples described above, the charge-discharge characteristics were found to improve by covering Si nanoparticles with carbon. However, it is unclear whether the improvement was achieved by carbon coating or by the increase in total carbon content in the electrode sheet. To make it clear, the charge-discharge characteristics of Si nanoparticles, to which CB was added by the same amount as the carbon covering the Si nanoparticles, were examined.

To examine the charge-discharge characteristics of the carbon-coated Si particles, by using the carbon-coated Si fabricated in Example 6, Si/C, CB, CMC, and SBR were mixed in the ratio of 67:11:13:9 to prepare slurry, which was then diluted to approximately two-fold and applied thinly to electrodes. The electrodes were used as working electrodes. The thickness of the coated electrodes ranged from approximately 10 to 20 μm.

To examine the charge-discharge characteristics of Si nanoparticles without carbon coating, by using the Si nanoparticles used in Example 6, nano-Si, CB, CMC, and SBR were mixed in the ratio of 67:11:13:9 to prepare slurry, which was then diluted to approximately two-fold and applied thinly to electrodes, which were used as working electrodes. The thickness of the coated electrodes ranged from approximately 10 to 20 μm.

The charge-discharge characteristics of Si nanoparticles, to which CB was added by the same amount as the carbon covering the Si nanoparticles, were examined. Since the carbon content in the Si/C described above was 19 wt %, by adding CB of the same amount as the carbon content, and using the nano-Si in Example 6, nano-Si, CB, CMC, and SBR were mixed at the ratio of 54:24:13:9 to prepare slurry, which was then diluted to approximately two-fold and applied thinly to electrodes. The electrodes were used as working electrodes. The thickness of the coated electrodes ranged from approximately 10 to 20 μm.

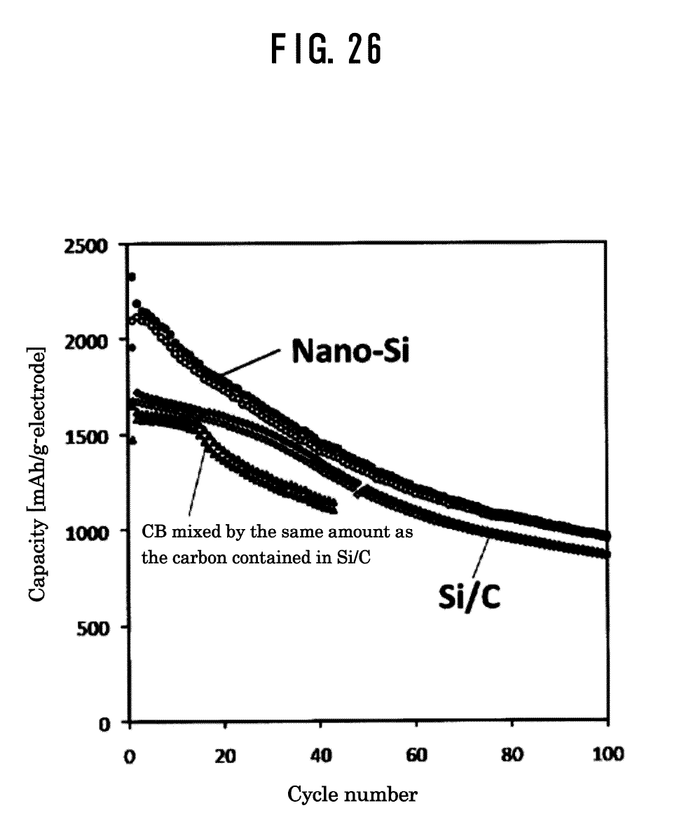

FIG. 26 shows the result of investigation of the effect of difference in the existence condition of carbon on the charge-discharge characteristics of Si nanoparticles. The vertical axis represents the capacity per weight of the electrode confirmed when charge-discharge was performed at a constant current, and the horizontal axis represents cycle number. The data plotted with the blacked-out and hollow symbols respectively represent the capacity obtained when Li was inserted and that obtained when Li was extracted. The change in coulombic efficiency is shown by the polygonal line. Note that the potential range of charge-discharge was from 0.01 to 1.5 V and current density was basically 200 mA/g except when CMC+SBR binder was used with VC, where the current density was 1000 mA/g only for 21 and subsequent cycles.

It is apparent that when Si/C is used, higher capacity is ensured than when Si nanoparticles without carbon coating are used. Meanwhile, when CB of the same amount as the carbon contained in Si/C is mixed, the performance is found to have decreased compared to the case where CB is not mixed.

It was found that simply increasing the carbon content in electrodes did not improve the nano-Si characteristics, but that it was essential to ensure uniform carbon coating.

The present invention is not limited to the embodiments described above, but includes those based on various design changes without departing from the scope of the present invention.

1.-17. (canceled)

18. A composite material, comprising:
agglomerated bodies of agglomerated Si nanoparticles; and
extendable-contractible accordion-shaped walls of carbon-layer, the walls being uniformly formed on the agglomerated bodies.

19. The composite material as set forth in claim 18, wherein the walls divide a space into sections including containing each of the Si nanoparticles and not containing each of the Si nanoparticles.

20. The composite material as set forth in claim 18, wherein a surface of the Si nanoparticles is oxidized.

21. The composite material as set forth in claim 18, wherein the carbon layer has an average thickness ranging from 0.34 to 30 nm.

22. The composite material as set forth in claim 18, wherein the Si nanoparticles have average particle size ranging from 1×10 to 1.3×10² nm.

23. The composite material as set forth in claim 18, wherein the carbon layer in a laminated graphene structure is formed on a surface of the Si nanoparticles.

24. The composite material as set forth in claim 18, wherein the composite material is used in a negative electrode of a lithium ion battery.

25. A method for fabricating a composite material, comprising:
heating an aggregate of Si nanoparticles;
forming a carbon layer on each of the Si nanoparticles using a source gas containing carbon, thereby making walls of carbon-layer, the walls dividing a space into sections including containing each of the Si nanoparticles and not containing each of the Si nanoparticles; and
performing heat treatment at a temperature higher than a level at which the carbon layer is formed.

26. A method for fabricating a composite material, comprising:
heating an aggregate of Si nanoparticles; and
forming a carbon layer using a pulsed CVD method on each of Si nanoparticles using a source gas containing carbon, thereby making walls of carbon-layer, the walls dividing a space into sections including containing each of the Si nanoparticles and not containing each of the Si nanoparticles; and
performing heat treatment at a temperature higher than a level at which the carbon layer is formed.

27. The method for fabricating the composite material as set forth in claim 25, comprising:
forming an oxide layer on a surface of each of the Si nanoparticles in the aggregate, thereby forming the walls on the oxide layer so that the walls surround each of the Si nanoparticles; and
dissolving the oxide layer, thereby making a hollow in a part between the carbon layer and each of the Si nanoparticles.

28. The method for fabricating the composite material as set forth in claim 26, wherein after the carbon layer is formed, heat treatment is performed at a temperature higher than a level at which the carbon layer is formed.

29. The method for fabricating the composite material as set forth in claim 25, wherein the aggregate is compressed to be molded into a pellet before forming the walls.

30. The method for fabricating the composite material as set forth in claim 26, wherein the aggregate is compressed to be molded into a pellet before forming the walls.

31. The method for fabricating the composite material as set forth in claim 25, wherein the carbon layer has an average thickness falling within a range from 0.34 to 30 nm.

32. The method for fabricating the composite material as set forth in claim 26, wherein the carbon layer has an average thickness falling within a range from 0.34 to 30 nm.

33. The method for fabricating the composite material as set forth in claim 25, wherein each of the Si nanoparticles have an average particle size falling within a range from 1×10 to 1.3×10² nm.

34. The method for fabricating the composite material as set forth in claim 26, wherein each of the Si nanoparticles have an average particle size falling within a range from 1×10 to 1.3×10² nm.
